(19) United States
(12) Patent Application Publication
(10) Pub. No.: US 2011/0102570 A1
(43) Pub. Date: May 5, 2011

(54) VISION BASED POINTING DEVICE EMULATION

(76) Inventors: Saar Wilf, Tel Aviv (IL); Haim Perski, Hod-HaSharon (IL); Amir Kaplan, Hod-HaSharon (IL)

(21) Appl. No.: 12/937,676

(22) PCT Filed: Apr. 6, 2009
(86) PCT No.: PCT/IL09/00386

§ 371 Date: Jan. 6, 2011

Related U.S. Application Data
(60) Provisional application No. 61/123,937, filed on Apr. 14, 2008.
(60) Provisional application No. 61/090,621, filed on Aug. 21, 2008.
(60) Provisional application No. 61/141,997, filed on Dec. 31, 2008.

(51) Int. Cl. H04N 7/18; G09G 5/00

(52) U.S. Cl. 348/77; 345/156; 348/E07.085

(57) ABSTRACT

A method for man machine interaction with an electronic device associated with an electronic display comprises capturing images of at least one hand positioned over an input device, tracking position or posture of the hand from the images; switching from interaction based on interaction with an input device to pointing device emulation in response to detecting a gesture performed with the hand, and emulating a pointing device based on the tracking, with the hand no longer performing the gesture.

### FIELD OF THE INVENTION

The present invention, in some embodiments thereof, relates to man machine interface assisted with computer vision and more particularly, but not exclusively to mouse emulation with computer vision.

### BACKGROUND OF THE INVENTION

The need for more comfortable, intuitive and portable input devices increases, as computers and other electronic devices become more prevalent in our everyday life. A pointing device is one type of input device that is commonly used for interaction with computers and other electronic device that are associated with electronic displays. Known pointing devices include an electronic mouse, a trackball, a pointing stick and a touchpad, a stylus and finger interaction with touch screen. Known pointing devices are used to control a location and/or movement of a cursor displayed on the associated electronic display. Pointing devices also typically provide for conveying commands, e.g. location specific commands by activating switches on the pointing device and/or by performing a learned gesture associated with a specific command.

U.S. Patent Application Publication No. 20080036732 entitled “Virtual Controller for Visual Displays”, the contents of which is incorporated herein by reference, describes utilizing vision-based computer techniques to control parameters for manipulating a visual display with recognized hand gestures. Emulation of mouse movement is provided while a pinching posture, e.g. a thumb and a finger of one hand touching (as if holding a small stylus) is recognized. A video camera directed toward the keyboard captures images of the hand. Computer vision techniques are used to identify an isolated background area (a hole) formed by the pinching posture. The user is required to maintain the pinching posture during mouse movement emulation and the center of the isolated background area is tracked Rapid forming, unforming, and reforming of the independent area is used to emulate a “clicking” of a mouse button. It is described that other control functions may be achieved by tracking two hands while performing a pinching gesture.

Taiwanese Patent No. TW466438 entitled “Construction method of gesture mouse”, the contents of which is incorporated herein by reference, describes a video camera directed toward a horizontal plane with respect to a vertical display that captures images of an object such as a hand. The maximum Y value of the hand is tracked and used to control cursor movement and the maximum X value tracked and used for key press control. Relative movement between the two tracking points is used emulate key pressing.

U.S. Patent Application Publication No. 20020075334 entitled “Hand gestures and hand motion for replacing computer mouse events”, the contents of which is incorporated herein by reference, describes computing device, a camera and software for recognizing the hand-gestures. Computer actions are initiated in response to detected user gestures. In one embodiment, the computer actions are events similar to that of the mouse, such as changing the position of a selector or cursor or changing other graphical information displayed to the user. The camera is described as being forward facing, e.g. facing a user's face.

An application called “uMouse” is described in www.larryo.org/work/information/umouse/index.html downloaded on Mar. 23, 2009 describes a software application for mouse emulation based on real-time visual tracking. Control of a cursor and mouse clicks are based on visual tracking of a user's head, hand or finger movements. The camera is described as forward facing camera, e.g. facing the users face. Mouse emulation is toggled by a keyboard shortcut or by button selection. Clicking can be provided by keeping the cursor still over a pre-defined time period and or by keeping the cursor still over a pre-defined time period and afterwards performing a predefined gesture.

In site www.matimop.org.il/newrdinf/company/c6908.htm#general downloaded on Mar. 23, 2009 there is described a method and system to simulate and view in real-time a keyboard on a display, with an image of the user's hands positioned over the displayed keyboard. It is described that any key or function can be assigned to the displayed keyboard. Output from keyboard hardware as a user types, as well as the specific positioning of the user's fingers above the actual keyboard is scanned, in order to obtain a real-time simulation. The image scanner locates, in real time, the positioning and movement of the user's hands and fingers, and displays them in the appropriate position over the keys on the displayed keyboard.

### SUMMARY OF THE INVENTION

According to an aspect of some embodiments of the present invention there is provided a system and method for emulating a pointing device including full mouse emulation based on hand movements performed above a keyboard and/or other interaction surface. According to some embodiments of the present invention, the system and method provides for naturally toggling between keyboard input and pointing device emulation (PDE) while maintaining the hands over the keyboard.

An aspect of some embodiments of the present invention is the provision of a method for man machine interaction with an electronic device associated with an electronic display, the method comprising: capturing images of at least one hand positioned over an input device; tracking position or posture of the hand from the images; switching from interaction based on interaction with an input device to pointing device emulation in response to detecting a gesture performed with the hand; and emulating a pointing device based on the tracking, with the hand no longer performing the gesture.

Optionally, the emulating is performed with multiple hand postures.

Optionally, the multiple hand postures are detected and used to control at least one parameter of the emulating.

Optionally, the emulating is performed while the hand is in a natural posture.

Optionally, the emulating includes object dragging emulation.

Optionally, object dragging emulation is initiated in response to detecting a pre-defined change in the hand posture.

Optionally, the pre-defined change is adduction of a thumb.

Optionally, the method comprises switching from pointing device emulation to interaction based on interaction with the input device in response to receiving input from the input device.

Optionally, the gesture is defined by a hand lifting followed by hand lowering motion.

Optionally, hand lifting and lowering is determined by tracking a change in a scale factor of the hand image.

Optionally, the gesture is defined by an adduction of the thumb followed by abduction of the thumb.

Optionally, adduction and abduction is determined by tracking a change in distance between the index finger and the thumb.

Optionally, the method comprises switching from pointing device emulation to interaction based on interaction with the input device in response to detecting a gesture performed with the hand.

Optionally, a gesture to switch into pointing device emulation and a gesture to switch out of pointing device emulation is a same gesture.

Optionally, emulating a pointing device includes emulating cursor control and mouse clicks.

Optionally, emulating a pointing device includes emulating scrolling, zoom control, object resizing control, object rotation control, object panning, open menu, and flipping pages.

Optionally, the object is a Window. Optionally, the method comprises separately tracking position or posture of a base of the hand and position and posture of at least one finger of the hand.

Optionally, the method comprises detecting if the at least one hand is a right hand or a left hand.

Optionally, the method comprises capturing images of both hands of a user; identifying which of the hands is the right hand and which of the hands is the left hand; and defining one of the right or the left hand as a primary hand for performing pointing device emulation in response to the identifying.

Optionally, the method comprises tracking a relative positioning between two hands; and identifying a gesture based on the tracking of the relative positioning.

Optionally, the method comprises providing the object movement based on tracking positions of the two hands.

Optionally, tracking position or posture includes tracking changes in position or posture.

Optionally, the input device is a keyboard.

Optionally, the method comprises emulating a mouse clicks with output received from the keyboard.

Optionally, the method comprises tracking a position of a base of the hand from the images; tracking at least one finger or part of a finger from the images; providing object movement control of an object displayed on the electronic display based on the tracking of the base of the hand; and providing interaction in addition to object movement control based on tracking the at least one finger or part of a finger.

An aspect of some embodiments of the present invention is the provision of a method for man machine interaction with an electronic device associated with an electronic display, the method comprising: capturing images of at least one hand; tracking a position of a base of the hand from the images; tracking at least one finger or part of a finger from the images; providing object movement control of an object displayed on the electronic display based on the tracking of the base of the hand; and providing interaction in addition to object movement control based on tracking the at least one finger or part of a finger.

Optionally, the object movement control is based on tracking the base of the hand and a first set of fingers of the hand and interaction in addition to object movement control based on tracking one or more fingers from a second set of fingers.

Optionally, providing interaction in addition to object movement control includes providing emulation of mouse clicking.

Optionally, providing interaction in addition to object movement control is based on gestures performed by the finger or part of the finger.

Optionally, a gesture associated with mouse click down is defined by adduction of the finger and mouse click up is defined by abduction of the finger.

Optionally, the finger is a thumb.

Optionally, a gesture associated with mouse click is defined by flexion and extension of a finger.

Optionally, a gesture associated with mouse click is defined by a finger lifting and lowering movement.

Optionally, the method comprises identifying the finger performing the gesture; and performing one of right mouse click, left mouse click, right mouse down, left mouse down, right mouse up, left mouse up based on the identifying.

Optionally, object movement control includes at least one of scrolling, rotation of the object, and resizing of the object and zooming.

Optionally, the object is a cursor.

Optionally, providing interaction in addition to object movement control includes changing a parameter of the object movement control.

Optionally, the parameter is resolution or sensitivity of movement control.

Optionally, the resolution is determined based on a distance between fingers.

Optionally, the images captured of the at least one hand are captured over a keyboard.

Optionally, the method comprises identifying if the at least one hand is a right hand or a left hand.

Optionally, the method comprises capturing images of both hands of a user; and identifying which of the hands is the right hand and which of the hands is the left hand.

Optionally, the method comprises controlling an object with pointing device emulation; and releasing control in response to detecting lifting of the hand.

An aspect of some embodiments of the present invention is the provision of a method for man machine interaction, the method comprising: capturing images of at least one hand positioned over an input device of an electronic device associated with an electronic display; tracking position of the hand from the images; controlling an object displayed on the electronic display with pointing device emulation; and releasing control in response to detecting hand lifting.

Optionally, the method comprises reinstating the control in response to detecting hand lowering.

Optionally, a position of the hand in a plane parallel to a plane on which the input device is positioned while lowering is different than the position of the hand at the onset of the lifting.

Optionally, the reinstating is in response to both detecting the hand lowering and detecting that the position while lowering is different than the position of the hand at the onset of the lifting.

Optionally, reinstating the control is in response to detecting hand movement substantially parallel to a plane on which the input device is positioned followed by hand lowering.

Optionally, control of the object is selected from one or more of: control of a cursor position, control of object zoom, control of object size, control of window scroll, control of object rotation.

Optionally, the method comprises tracking a relative positioning between two hands; and identifying a gesture based on the tracking of the relative positioning.

Optionally, the method comprises tracking the position or posture of the hand from the images, wherein the images of the hand are captured over the keyboard; scanning keyboard output substantially concurrently with the tracking; and defining functionality of the keyboard output based on the tracking.

An aspect of some embodiments of the present invention is the provision of a method for man machine interaction, the method comprising: capturing images of at least one hand positioned over a keyboard of an electronic device associated with an electronic display; tracking the position or posture of the hand from the images; scanning keyboard output substantially concurrently with the tracking; and defining functionality of the keyboard output based on the tracking.

Optionally, the method comprises tracking position of one or more fingers with respect to the keyboard.

Optionally, the method comprises identifying which finger was used to press a key on the keyboard and assigning functionality to the key based on the finger used for to press the key.

Optionally, the keyboard output is used for emulating mouse clicks.

Optionally, the functionality of the keyboard output is defined based on identification of a finger used to press a key of the keyboard.

Optionally, the functionality of the keyboard output is defined based on both identification of a finger used to press a key on the keyboard and based on the keyboard output.

Optionally, the method comprises controlling cursor movement based on the tracking, cursor movement control continued while the hand is performing a gesture with hand motion; restoring cursor position to a position prior to performing the gesture in response to identifying the gesture.

An aspect of some embodiments of the present invention is the provision of a method for man machine interaction, the method comprising: capturing images of at least one hand positioned over an input device of an electronic device associated with an electronic display; tracking hand motion based on information from the images; controlling cursor movement based on the tracking, cursor movement control continued while the hand is performing a gesture with hand motion; and restoring cursor position to a position prior to performing the gesture in response to identifying the gesture.

Optionally, the method comprises toggling a field of view of a camera between a first and second field of view, wherein the first field of view is directed toward a user's face interacting with an electronic device associated with an electronic display and the second field of view is directed toward a keyboard associated with the electronic device; identifying the keyboard based on images captured by the camera; and providing pointing device emulation capability based on computer vision of the users hand while the camera view is directed toward the keyboard.

An aspect of some embodiments of the present invention is the provision of a method for man machine interaction, the method comprising: toggling a field of view of a camera between a first and second field of view, wherein the first field of view is directed toward a user's face interacting with an electronic device associated with an electronic display and the second field of view is directed toward a keyboard associated with the electronic device; identifying the keyboard based on images captured by the camera; and providing pointing device emulation capability based on computer vision of the users hand while the camera view is directed toward the keyboard.

Optionally, the method comprises tracking position or posture of said hand from said images of the second field of view; switching from interaction based on keyboard keying to pointing device emulation in response to detecting a gesture performed with the hand; and emulating a pointing device based on the tracking, the hand no longer performing the gesture.

Optionally, the switching is provided by a moving mirror or a prism.

Optionally, the method comprising determining if the hand is left or right hand; and emulating a pointing device for controlling an object displayed on the electronic display based on tracking the at least one of the right or left hand.

An aspect of some embodiments of the present invention is the provision of a method for man machine interaction with an electronic device associated with an electronic display, the method comprising: capturing images of at least one hand; tracking position or posture of the at least one hand from the images; determining if the hand is left or right hand; and emulating a pointing device for controlling an object displayed on the electronic display based on tracking the at least one of the right or left hand.

Optionally, one of a right or left hand is defined as a primary hand for performing pointing device emulation and the other hand is defined as a secondary hand

Optionally, a first set of pointing device emulation functions is performed by tracking the primary hand.

Optionally, the first set of pointing device emulation functions includes cursor movement control and mouse click emulation.

Optionally, a second set of pointing device emulation functions is performed by tracking the secondary hand.

Optionally, a third set of pointing device emulation functions is performed by tracking both primary and secondary hands.

Optionally, the emulating is provided with the secondary hand in response to a detected absence of the primary hand.

Optionally, both the primary hand and secondary hand is tracked, wherein the tracking the primary hand provides for object movement control and the tracking of the secondary hand provides for interaction with the electronic device in addition to object movement control.

Optionally, the primary hand is pre-defined by the user as one of the right or the left hand.

Optionally, the method comprises defining a resolution or sensitivity of the object control based on the posture of the hand.

An aspect of some embodiments of the present invention is the provision of a method for man machine interaction, the method comprising: capturing images of at least one hand; tracking a position and posture of the at least one hand from the images captured; providing object control of an object displayed on the electronic display based on the tracking of the position of the hand; and defining a resolution or sensitivity of the object control based on the posture of the hand.

Optionally, tracking a position and posture of the at least one hand includes tracking a position of a base of the at least one hand and tracking at least one finger of the hand.

Optionally, a distance between at least two fingers defines the resolution of object control.

Optionally, the images are captured from at least one camera capturing images of the hand over an input device and wherein the images provide for determining a height of the hand above an input device; the method further comprising: tracking a position of the hand over the input device; releasing control on the object in response to the hand positioned at a pre-defined height above the input device.

An aspect of some embodiments of the present invention is the provision of a method for man machine interaction with an electronic device associated with an input device and an electronic display, the method comprising: capturing images of at least one hand above the input device from at least one camera, wherein camera data output provides for determining a height of the hand above an input device; tracking position of the at least one hand based on the images captured; controlling an object displayed on the electronic display based on the tracking; and releasing control on the object in response to the hand positioned at a pre-defined height above the input device.

Optionally, the pointing device emulation server is operable to reinstate the control in response to a detected depth of the hand within the pre-defined depth.

Optionally, the camera system includes two cameras distances from each other.

Optionally, the camera system includes a 3-D camera. An aspect of some embodiments of the present invention is the provision of a method for man machine interaction with an electronic device associated with an electronic display, the method comprising: capturing images of at least one hand positioned over an input device; tracking position or posture of the hand from the images; switching from interaction based on interaction with an input device to interaction based on computer vision; and interacting with the electronic device based on the tracking, with the hand no longer performing the gesture.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram of an exemplary PDE system setup in accordance with some embodiments of the present invention;

FIG. 2 is a diagram describing an exemplary method for toggling between PDE control and keyboard typing control in accordance with some embodiments of the present invention;

FIGS. 3A-3B are a simplified illustration of a detected hand contour in an adducted and abducted posture with a polygon defining an area spanned by the contour in accordance with some embodiments of the present invention;

FIG. 4 is a flow chart showing an exemplary method for detecting an adduction and abduction posture of a hand in accordance with some embodiments of the present invention;

FIG. 5 is a simplified diagram of an exemplary hand gesture defined by movements toward and away from a camera in accordance with some embodiments of the present invention;

FIG. 6 is a flow chart showing an exemplary method for toggling between PDE mode and keyboard typing mode based on three dimensional information of the hand position in accordance with some embodiments of the present invention;

FIG. 7 is a simplified diagram of one hand performing exemplary mouse emulation in accordance with some embodiments of the present invention;

FIG. 8 is a flow chart showing an exemplary method for performing mouse emulation in accordance with some embodiments of the present invention;

FIG. 9 is a simplified diagram of exemplary line segments defined to separate a hand area from each finger area in accordance with some embodiments of the present invention;

FIG. 10 is a flow chart showing an exemplary method for separating a hand area from finger areas in accordance with some embodiments of the present invention;

FIG. 11 is a simplified diagram of an exemplary ellipse defined and used to determine hand orientation in accordance with some embodiments of the present invention;

FIG. 12 is a flow chart showing an exemplary method for determining an orientation of a hand in accordance with some embodiments of the present invention;

FIGS. 13A-13B are two simplified diagram of exemplary gestures performed with a single hand that are used for manipulating objects on a visual display in accordance with some embodiments of the present invention;

FIG. 14 is a simplified diagram of two hands performing exemplary PDE in accordance with some embodiments of the present invention;

FIG. 15 is a flow chart showing an exemplary method for performing PDE with two hands in accordance with some embodiments of the present invention;

FIG. 16 is a flow chart showing an exemplary method for identifying a user operating a computing device in accordance with some embodiments of the present invention;

FIG. 17 is a flow chart showing an exemplary method for identifying and tracking hand motion from a video data stream in accordance with some embodiments of the present invention; and

FIG. 18 is a flow chart showing an alternate method for detecting a hand on a video data stream in accordance with some embodiments of the present invention;

FIG. 19 is a simplified block diagram of an exemplary PDE system integrated on a personal computer in accordance with some embodiments of the present invention.

### DESCRIPTION OF SPECIFIC EMBODIMENTS OF THE INVENTION

The present invention, in some embodiments thereof, relates to man machine interface assisted with computer vision and more particularly, but not exclusively to mouse emulation with computer vision. As used herein mouse emulation includes one or more of object movement control, e.g. cursor control, and mouse clicking. In some exemplary embodiments, mouse emulation additionally includes scrolling, zoom control, object resizing control object panning and object rotation control, flipping pages, Window movement and/or resizing and menu opening.

Despite constant improvements, existing pointing devices are still cumbersome and inefficient. The present inventors have found that one of the deficiencies of known pointing devices used in conjunction with keyboard input for man machine includes the need to frequently move a hand away from a keyboard and then back again in order to operate the pointing device. Extensive use of a pointing device is also known to cause fatigue. The present inventors have also found that known pointing devices are limited in the accuracy in movement control that they can provide. Some pointing devices, such as a mouse, are further limited in that they are not easy to use in a mobile computing environment.

An aspect of some embodiments of the present invention provides for mouse emulation by tracking both finger and hand movement above a keyboard (or other input device, e.g. an input device including an interaction surface) using computer vision. According to some embodiments of the present invention, movement and/or positioning of one or more fingers is tracked separately from movement of the base of the hand and/or the base of the hand and one or more other fingers.

As used herein the term base of the hand refers to the hand not including the fingers and the term hand refers to the entire hand including the fingers.

According to some embodiments of the present invention, movement of the base of the hand provides for cursor or pointer movement control while posture and/or gestures of one or more fingers provide for mouse click emulation. In some exemplary embodiments, mouse click emulation includes left and right click and double click and left and right mouse click down and mouse click up.

The present inventors have found that by separately tracking the base of the hand from one or more fingers, cursor movement control and button click emulation can be provided concurrently with the same hand without interfering with each other. The present inventors have found that finger movements and postures can be performed without affecting cursor position and movement. The present inventors have found that by tracking both hand base and finger movements separately, control of multiple parameters can be achieved with PDE. In some exemplary embodiments, panning, scrolling, rotating, and zooming are controlled based on tracking both hand base movements and finger movements of one hand.

A hand's posture is the status of the hand's joints. One example of a posture is a fist, in which all finger joints are flexed. Another example of a posture is a pointing posture in which all fingers except one are flexed. Another example of a posture is adduction (separation) and/or abduction (bringing together) of one or more fingers. An example of a posture of a base of the hand includes different rotation of the hand.

As used herein, a hand gesture is a combination of hand postures or hand positions performed in succession. According to some embodiments of the present invention, gestures are defined based on hand movements, based on finger movements, and/or based on a combination of hand and finger movements. An example of a hand gesture includes moving the hand right and left. An example of a finger gesture includes flexing and extending the fingers.

An aspect of some embodiments of the present invention provides for switching Pointing Device Emulation (PDE) mode on and/or off in response to recognition of a pre-defined gesture. The present inventors have found that requiring that a single specific posture be maintained throughout mouse emulation as is suggested by incorporated U.S. Patent Application Publication No. 20080036732 is uncomfortable, may cause fatigue and limits the number of different types of gestures that can be performed. According to some embodiments of the present invention, once PDE mode is switched on in response to gesture recognition a natural hand posture with hands slightly curved is used to perform PDE.

In some exemplary embodiments, PDE control is performed with the hand leaning over the keyboard while moving across the keyboard. In some exemplary embodiments, a user can alter and/or use different hand postures without effecting PDE control. For example, PDE control may be performed with a user's fingers resting flat over the keyboard and/or may be performed with hands lifted hands over the keyboard and fingers curved in a natural posture. The present inventors have found that by switching into PDE mode with a gesture, the base of the hand can be tracked for cursor control and all the fingers are free to emulate other mouse functions and/or other user input.

In some exemplary embodiments, specific postures are defined and used to relay specific commands or input to the host during PDE. In some exemplary embodiments, PDE mode is switched off in response to keyboard input. In some exemplary embodiments, PDE mode is toggled in response to gesture recognition of a gesture pre-defined for toggling between PDE mode and keyboard mode.

An aspect of some embodiments of the present invention provides for pointing device emulation over a keyboard (or other input device such as an input device including an interaction surface) based on tracking finger and/or hand movements using computer vision providing three-dimensional information. According to some embodiments of the present invention, toggling between keyboard control and PDE occurs in response to a determined height and/or change of height of a hand above a keyboard (or other input device such as an input device including an interaction surface).

According to some embodiments of the present invention, one or more gestures are defined based on fingers movements, e.g. movements of the fingers relative to the base of the hand and/or movement between fingers. In some exemplary embodiments, abduction, adduction of one or more fingers or abduction followed by adduction is defined as a gesture and used to relay a command to an associated host. In some exemplary embodiments, abduction, adduction movements of one or more fingers, e.g. the thumb are used to toggle a user in and out of PDE mode. In some exemplary embodiments, finger movement and or a relative positioning of two or more fingers is a gesture used to controls cursor sensitivity to hand movement. In some exemplary embodiments, movement of a thumb and tip of a pointer finger toward and away from each other provide for zooming in and out.

According to some embodiments of the present invention, one or more gestures are defined based on movement of the entire hand. According to some embodiments of the present invention, one or more gestures are defined based on movement of the base of the hand and one or more fingers, e.g. the pinky and ring finger. In some exemplary embodiments, rotation of the hand, e.g. on a plane parallel to an interaction surface is defined as a gesture to rotate an object. In some exemplary embodiments, lifting and lowering of the hand, e.g. hand base together with the fingers is defined as a gesture.

The present inventors have found that using the entire hand to perform a gesture may cause ambiguity when hand base motion is defined for cursor control. Occasionally, a hand movement that is intended as a gesture may also cause unintentional cursor movement. Typically, the cursor will follow movement of the base of the hand while the gesture is being performed and/or until the gesture is recognized. Additionally, a gesture performed by one part of the hand (e.g. the thumb) that should not by itself move the cursor may cause unintentional movement of other parts of the hand, which do affect the cursor. An aspect of some embodiments of the present invention provides for providing cursor movement in response to hand base movement and reinstating cursor position in response to gesture recognition. Typically, the cursor is reinstated to the position directly preceding the start of the gesture event.

An aspect of some embodiments of the present invention provides for extending range of motion of an object on an electronic display by temporarily releasing PDE and then reengaging hold on the object. Exemplary objects include a cursor, a pointer and/or one or more selection points used to rotate and zoom an object associated with the selection point. According to some embodiments of the present invention, lifting the hand is defined as a gesture used for temporarily releasing PDE hold on a displayed object and lowering of the hand is defined as a gesture for reengaging hold on the object. According to embodiments of the present invention, this function is analogous to lifting a mouse up and then lowering it continue moving a cursor over an extended range and/or lifting and then lowering a finger from a touch pad for the same purpose.

An aspect of some embodiments of the present invention provides for defining one of the right or left hand as a primary hand for providing PDE control. In some exemplary embodiments, PDE is only activated in response to recognizing the primary hand. In some exemplary embodiments, the primary hand is specifically defined for cursor movement control while the other hand, e.g. the secondary hand is used for controlling other parameters, e.g. mouse click emulation. In some exemplary embodiments, in response to computer vision detection of two hands, the hand designated for cursor control is identified and hand base movement of only the primary hand is tracked for cursor movement control. In some exemplary embodiments, keyboard input can be provided by the secondary hand during PDE control with the primary hand (without deactivating PDE mode). In some exemplary embodiments, keyboard input received by the secondary hand during PDE with the primary hand has specific functionality. In some exemplary embodiments, keyboard input provided in conjunction with PDE emulates mouse clicking.

An aspect of some embodiments of the present invention provides for PDE control with two hands in response to a dedicated gesture. In some exemplary embodiments, relative movement between the hands, e.g. distance between the hands is tracked and used to control zooming, e.g. zoom in and zoom out. In some exemplary embodiment, an angle between a line connecting two hands is used for rotating an object. In some exemplary embodiments, each hand controls a separate object displayed on an electronic display. According to some embodiments of the present invention, finger movements from each hand are tracked and gestures are defined with movement performed with a selected combination of fingers. In some exemplary embodiments, one hand operates the keyboard concurrently with another hand performing PDE.

An aspect of some embodiments of the present invention provides for combining keyboard input with finger positioning based on computer vision to enhance functionality of the keyboard and/or enhance PDE control. According to some embodiments of the present invention, fingers tip positions are tracked to determine which finger is used to press a key on a keyboard. In some exemplary embodiments, different fingers used to depress a same key provides for different functionality. In one exemplary embodiment, depressing a letter key with a thumb is equivalent to pressing a shift key together with the letter key. In other exemplary embodiments, depressing any key with the index finger during PDE mode signifies left click while depressing any key with the middle finger signifies right click. According to some embodiments of the present invention, specific finger used to depress a key on a keyboard is correlated with the key selected. According to some embodiments of the present invention, fingertip tracking is implemented for providing a virtual keyboard. In some exemplary embodiments, finger tip positions over a flat surface are tracked while a user can view corresponding finger position on a virtual keyboard displayed on an electronic display. In some exemplary embodiments, finger lifting and lowering is defined as a gesture to select a key on the virtual keyboard.

An aspect of some embodiments of the present invention provides for identifying a user during interaction with the host based on feature extraction of the visualized hand and fingers. According to some embodiments of the present invention, user identification is based on detected dimensions of the finger and/hand. In some exemplary embodiments, a user's age is approximately identified based on feature extraction of finger and hand dimensions.

An aspect of some embodiments of the present invention provides for toggling between computer vision based emulation of hand movements above a keyboard and video capture of a persons face. According to some embodiments of the present invention, a computer vision unit associated with the computing device provides for imaging an area over the keyboard and for forward facing imaging of an area generally parallel to the display, e.g. for imaging a user's face. According to some embodiments of the present invention, a camera's view is toggled from a down facing position to a forward facing position with respect to the electronic display. In some exemplary embodiments, toggling a camera's provides for using the camera intermittently for PDE and video conferencing. According to some embodiments of the present invention, computer vision based PDE with hand movements above a keyboard is combined with computer vision recognition of other gestures performed by a users head. In some exemplary embodiments, head nodding is used as a confirmation gesture for executing commands emulated with hand motion. According to some embodiments of the present invention, PDE is provided in response to recognition of the keyboard in the background.

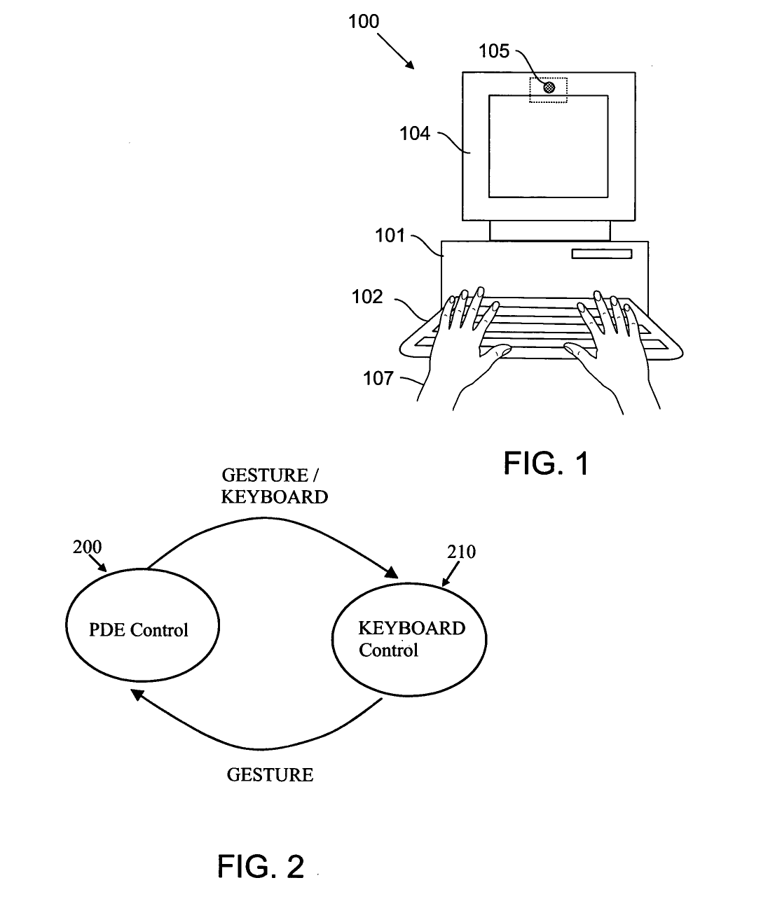

In some exemplary embodiments, separate cameras are used for capturing images of the keyboard area and forward facing images. In some exemplary embodiments, a single wide angle camera is used for capturing image of both the keyboard area and a user facing a monitor. Typically, when using a wide angle camera only a portion of the image area is defined for PDE, e.g. the portion viewing the keyboard or other defined user interaction surface. Reference is now made to FIG. 1 showing a simplified diagram of an exemplary PDE system setup in accordance with some embodiments of the present invention. According to some embodiments of the present invention, PDE capability is integrated with a computing device 101 associated an electronic display 104 and an interaction surface 102 to provide PDE enabled system 100. According to some embodiments of the present invention, the computing device is a personal computer that may be portable, e.g. desktop, laptop, and netbook computer. According to some embodiments of the present invention PDE is based on tracking hand movements, e.g. hand 107 over interaction surface 102 with one or more video cameras 105. According to some embodiments of the present invention, a view of the camera 105 is oriented toward interaction surface 102 that is typically used by a user to interact with computing device 101. Typically, camera 105 is positioned above the interaction surface and its view is directed downward. The positioning and viewing field of camera in accordance with some embodiments of the present invention is described in more detail herein.

Typically the interaction surface is and/or includes a keyboard. In some exemplary embodiments, the interaction surface is and/or includes a touch-pad where the user interacts with computing device 101 by touching interaction surface 102 with one or more fingers and/or a stylus. In some exemplary embodiments, the interaction surface is the surface of an electronic display, e.g. such as a laptop system with two displays, the lower one used for interaction. In some exemplary embodiments, the cameras view is oriented toward the display e.g. when the interaction surface is the surface of the display 104. According to some embodiments of the present invention hand movements for PDE are performed in the vicinity of interaction surface 102, e.g. directly over interaction surface 102. According to some embodiments of the present invention, a user is able to toggle between PDE interaction and keyboard interaction without distancing or substantially distancing the user's hand from the keyboard.

Typically, a user will operate the keyboard and pointing device at different times. It is therefore desirable that the PDE server not send PDE messages during operation of the keyboard. In some exemplary embodiments, the system 100 activates PDE control and/or mode upon detection of a pre-defined hand gesture. In some exemplary embodiments, a same or different hand gesture is used to deactivate PDE control so that a user may continue to type without generating undesired PDE messages.

Toggling Between PDE Mode and Interaction with an Input Device

Reference is now made to FIG. 2 showing a diagram describing an exemplary method for toggling between PDE mode and keyboard typing mode in accordance with some embodiments of the present invention. According to some embodiments of the present invention camera 105 is operative to capture a stream of images of a keyboard of computing device 101 during its operation and to identify and track hands movements of one or more hand over the keyboard. Methods for extracting a hand(s) in an image and tracking it are described in detail herein. In some exemplary embodiments, during keying (keyboard input), PDE mode is turned off and keyboard control 210 is active.

According to some embodiments of the present invention, to switch from keyboard control 210 to PDE control 200 a user performs a pre-defined gesture.

According to some embodiments of the present invention, once the pre-defined gesture is performed and recognized by the system the user can perform PDE while leaning hands over keyboard with fingers lightly resting on the keys (in a flat or slightly curved posture) but without pressing the keys, by lifting hands over the keyboard in a natural posture, e.g. with curled fingers and/or with other postures.

In some exemplary embodiments, PDE control 200 is defined for a specific hand and only a gesture performed with that hand, e.g. left or right hand, provides for entering PDE mode. According to some embodiments of the present invention, a user can switch between PDE control 200 and keyboard control 210 simply by keying on the keyboard. In some exemplary embodiments, switching to keyboard control 210 is provided when keying with the hand designated for PDE control. In some exemplary embodiments, a gesture is used to switch to keyboard control 210. In some exemplary embodiment a same gesture is used to switch into and out of PDE control 200.

According to some embodiments of the present invention, at system startup and in response to detecting the presence of one or more hands and/or detecting a presence of specific hand defined for PDE mode, PDE mode is initiated. According to some embodiments of the present invention, PDE mode is activated in response to detecting a hand over the keyboard and not receiving input from the keyboard for a pre-determined period of time.

In some exemplary embodiments PDE mode is the default mode and is disabled in response to input from a keyboard, in response to a gesture and or in response to absence of a hand within the camera view. In some exemplary embodiments, while PDE mode is disabled, one or more features of a detected hand is characterized and tracked for purposes other than mouse emulation, e.g. identification.

According to some embodiments of the present invention, posture detection is used in place and/or in addition to gesture detection for toggling between PDE mode and keyboard typing mode. In some exemplary embodiments, PDE mode is activated in response to detecting a rapid abduction and adduction of one or more fingers on a hand. In some exemplary embodiments, PDE is activated in response to detecting a rapid movement of the thumb towards the index finger. In some exemplary embodiments, PDE is activated in response to detecting a rapid lifting and lowering of the hands.

In some exemplary embodiments, changing a posture of the hand during PDE provides for enhanced control of an object displayed on an electronic display. For example, in some exemplary embodiments, object drag control is provided by thumb adduction to initiate object drag and then moving the hand while the thumb is maintained the adducted posture. Object dragging can then be released by abducting the thumb.

According to some embodiments of the present invention, the posture and/or gesture is not required to be maintained over the duration of PDE.

According to some embodiments of the present invention, PDE is implemented with a hand(s) extended over the keyboard positioned in a natural posture or while leaning (or resting) on the keyboard without pressing keys. The present inventors have found that implementing PDE with an extended hand is more natural, intuitive and enables more flexibility in performing gestures as compared to the pinch posture suggested by incorporated US Publication 20080036732.

In some exemplary embodiments, toggling between PDE mode and keyboard mode is accompanied by a visual or auditory feedback indication. In some embodiments of the present invention graphical symbols are displayed on display 104 to indicate a current input mode. Typically, a first symbol is used to indicate “PDE On” and a second symbol to indicate “PDE Off”. Optionally, the graphical symbols follow the position of the cursor on display 104. Optionally, the graphical symbols are semi transparent so as not to obstruct other information on display 104. In some exemplary embodiments, graphical symbols are used to indicate detection of gestures and generation of events, such as left click, right click, left button down, and right button down.

### Exemplary Gestures for Toggling In and Out of PDE Mode

### Abduction and Adduction Gestures

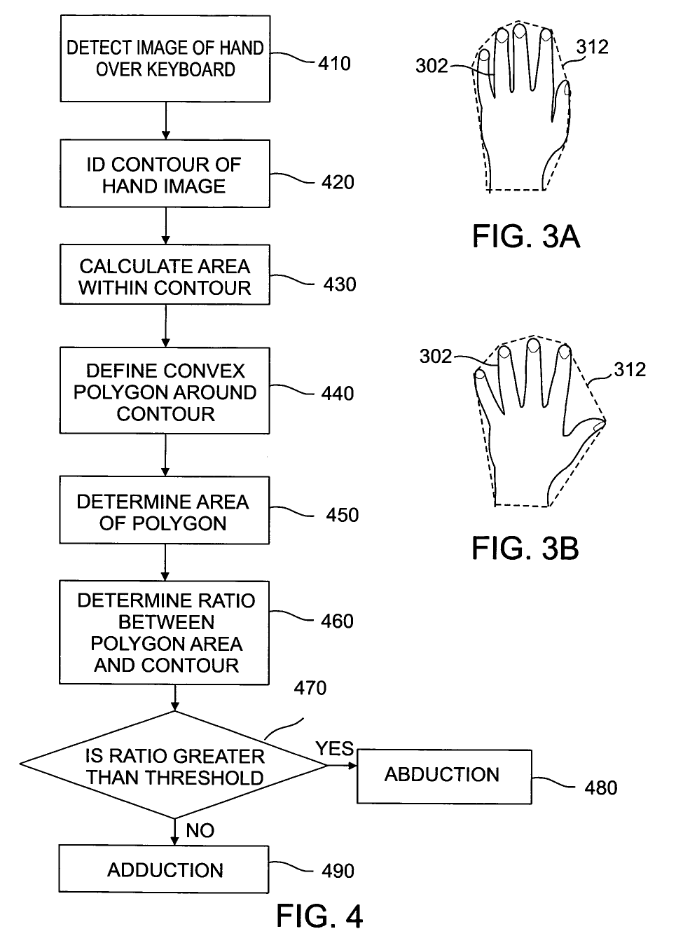

Reference is now made to FIGS. 3A-3B showing a simplified illustration of a detected hand contour in an adducted and abducted posture with a polygon defining an area spanned by the contour and to FIG. 4 showing a flow chart showing an exemplary method for detecting an adduction and abduction posture of a hand in accordance with some embodiments of the present invention. In FIG. 3A hand 107 is in a relatively adducted posture and in FIG. 3B hand 107 is in a relatively abducted posture.

According to some embodiments of the present invention, an image of a hand over a keyboard is identified from a video stream of images (block 410). According to some embodiments of the present invention, the contour 302 of hand 107 is identified (block 410). According to some embodiments of the present invention, an area enclosed by the contour is determined (block 430). According to some embodiments of the present invention, a convex polygon, e.g. polygon 312 or polygon 313, based on the contour is defined (block 440). Typically, the polygon has a predefined shape, e.g. rectangular, pentagon, hexagon, octagon, and enneagon and is fitted to the dimensions of the contour. According to some embodiments of the present invention, the polygon defined is the smallest polygon that fully encloses the contour. In some exemplary embodiments, an alternate closed shape is defined to encompass the contour, e.g. ellipse. Typically, the polygon closely follows the shape of the contour. Typically one or more points of the contour are used to define the dimensions of the polygon or other closed shape. According to some embodiments of the present invention an area of the defined polygon is determined (block 450).

According to some embodiments of the present invention, a ratio between an area defined by a contour 302 and an area defined by a constructed polygon encompassing the contour, e.g. polygon 312 and 313 is determined to identify an adduction and/or an abduction posture (block 460). As can be seen in FIGS. 3A and 3B, an area defined by polygon 312 is larger than an area defined by polygon 313 while the area defined by the contour remains the same. As such the ratio of an abducted hand, e.g. the ratio defined by polygon 313 with respect to contour 302 will be larger than the ratio of the same hand adducted, e.g. the ratio defined by polygon 312 with respect to contour 302. According to some embodiments, a query is made to determine if the ratio between the polygon and the contour is above a threshold for abduction (block 470). In some exemplary embodiments, if the ratio is greater than a pre-defined threshold, the posture is defined as an abduction posture (block 480). In some exemplary embodiments, if the ratio is less than the pre-defined ratio, the posture is defined as an adduction posture (block 490). In some exemplary embodiments, separate thresholds are defined for abduction and adduction. In some exemplary embodiments for postures that have a ratio that falls in between the adduction and abduction ratio, posture is resolved in subsequent images captured. It is noted that although in FIG. 3B a plurality of fingers are shown to abduct as compared to FIG. 3A, in some exemplary embodiments, only one finger, e.g. the thumb is abducted and changes in the ratio of polygon 312 and hand contour 302 is due to thumb abduction and adduction.

### Change in Z Position of the Hand Gesture

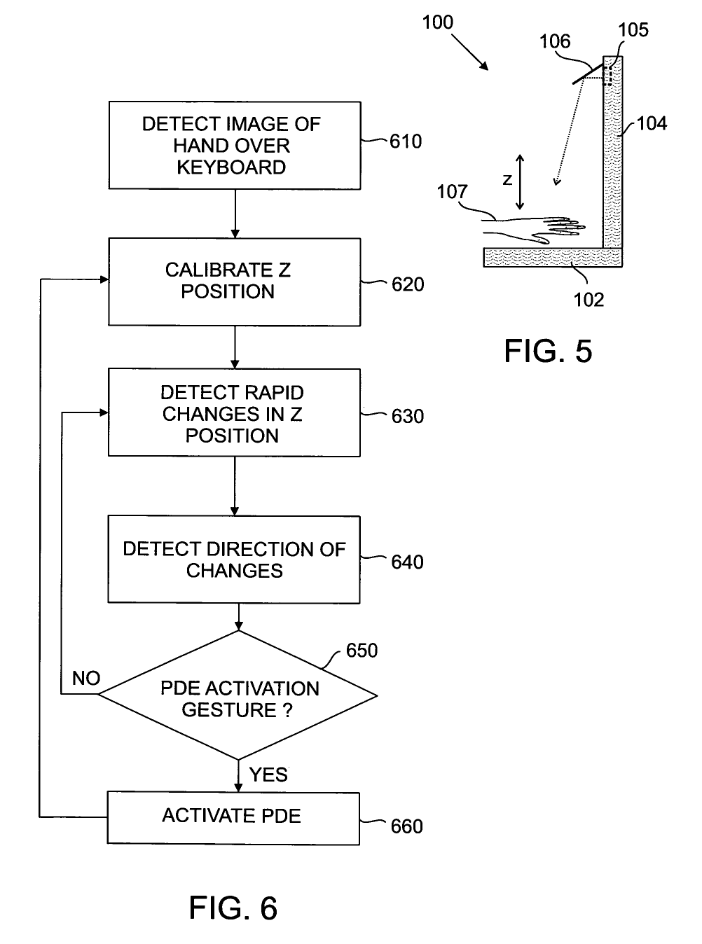

Reference is now made to FIG. 5 showing a simplified diagram of an exemplary hand gesture defined by movements toward and away from a camera in accordance with some embodiments of the present invention. According to these embodiments, detected relative movement of hand 107 in the Z direction, e.g. toward and away from camera 105, is used to toggle between keyboard mode and PDE mode. In some exemplary embodiments a quick upwards movement of the hand activates PDE mode. In other exemplary embodiments, quick up and down movement of the hand activates PDE mode.

In some exemplary embodiments, the upwards movement, e.g. a quick upward movement is used to temporarily release hand base movement from cursor control and a downward movement, e.g. quick downward movement is used to reengage hand base movement for cursor control. In some exemplary embodiments, temporary release of cursor control allows a user to reposition hand base back into a field of view of the camera for continued movement of a cursor in a particular direction. In some exemplary embodiments, temporary release of cursor control allows a user to reposition hand base back into a field of view of the camera for continued scrolling in a particular direction or other direction. In some exemplary embodiments, rapid lifting, followed by translation of hand with respect to image coordinates, followed by rapid lowering is used as a gesture to temporarily release and reinstate hold on an object being manipulated.

In some exemplary embodiments, a scale factor of an identified hand over a plurality of images is used to determined movement in z axis. For example, a positive scale factor may stand for tracking points that move away from each other, signifying that the tracked object is moving towards the camera. In another example, a negative scale factor stands for tracking points that are moving towards each other, signifying that the tracked object is moving away from the camera.

It is noted that in some exemplary embodiments, a reflecting element 106 is used to direct the view of a forward facing camera 105 toward keyboard 102. In others it is permanently directed toward the keyboard. In yet others the direction of the camera is rotated.

According to some embodiments of the present invention, camera 105 captures a three dimensional position of the hand. According to some embodiments of the present invention, three dimensional position is generated by a three dimensional camera, such as a camera provided by 3DV Systems of Yokneam, Israel (www.3dvsystems.com/) downloaded on Mar. 25, 2009. In some exemplary embodiments, movements of the hand and/or fingers in the z-axis (i.e. towards the camera or away from it) are determined by analyzing a video stream of a 2D camera. A typical way to determine z-axis movements is by analyzing the relative movement of multiple tracking points; if the points are moving away from each other, a movement towards the camera is reported. If the points are moving towards each other, a movement away from the camera is reported.

According to some embodiments of the present invention three dimensional tracking is provided by two or more cameras providing stereoscopic imaging of the hands above the keyboard. In some exemplary embodiments, switching PDE mode is activated in response to a detected height of the hand base over the keyboard. In some exemplary embodiments, PDE control is activated while the base of the hand between two predefined heights, e.g. an upper and lower threshold.

Reference is now made to FIG. 6 showing a flow chart of an exemplary method for toggling between PDE mode and keyboard typing mode based on three dimensional information of the hand position in accordance with some embodiments of the present invention. According to these embodiments, in response to detection of an image of a hand over a keyboard (block 610), its Z position is determined and defined as the initial Z position (block 620). According to some embodiments of the present invention, changes in Z position of the hand are tracked to detect rapid changes in height (block 630) as well as the direction of change (block 640). In response to the magnitude of movement and the direction of movement and the speed of movement meeting a pre-defined criteria for switching to PDE mode (block 650), PDE mode is activated (block 660). In some exemplary embodiments, a gesture for activating PDE mode includes rapid lifting followed by rapid lowering of the hand. In some exemplary embodiments, such a gesture can be used to toggle in both directions between PDE mode and keyboard mode. In some exemplary embodiments, different gestures are defined for activating PDE mode and for activating keyboard mode.

During operation of computing device 101, a user may wishes to exit PDE mode for reasons other than using the keyboard, for example to move his hand to a better position within the viewing area of the camera, or to a more comfortable location. According to some embodiments of the present invention, toggling between keyboard mode and PDE mode may be used for such a purpose. In some exemplary embodiment, a user deactivates PDE mode by moving hand 107 up, e.g. toward the camera without affecting the cursor's position. Now that PDE is deactivated a user is free to relocate hand 107, e.g. moving the hand in parallel to the keyboard surface without affecting the cursor's position. According to some embodiments of the present invention, PDE mode is reactivated by moving the hand down towards the keyboard. Such a sequence of movements is similar to a repositioning of a standard mouse (e.g. when reaching the edge of a table).

### Mouse Emulation

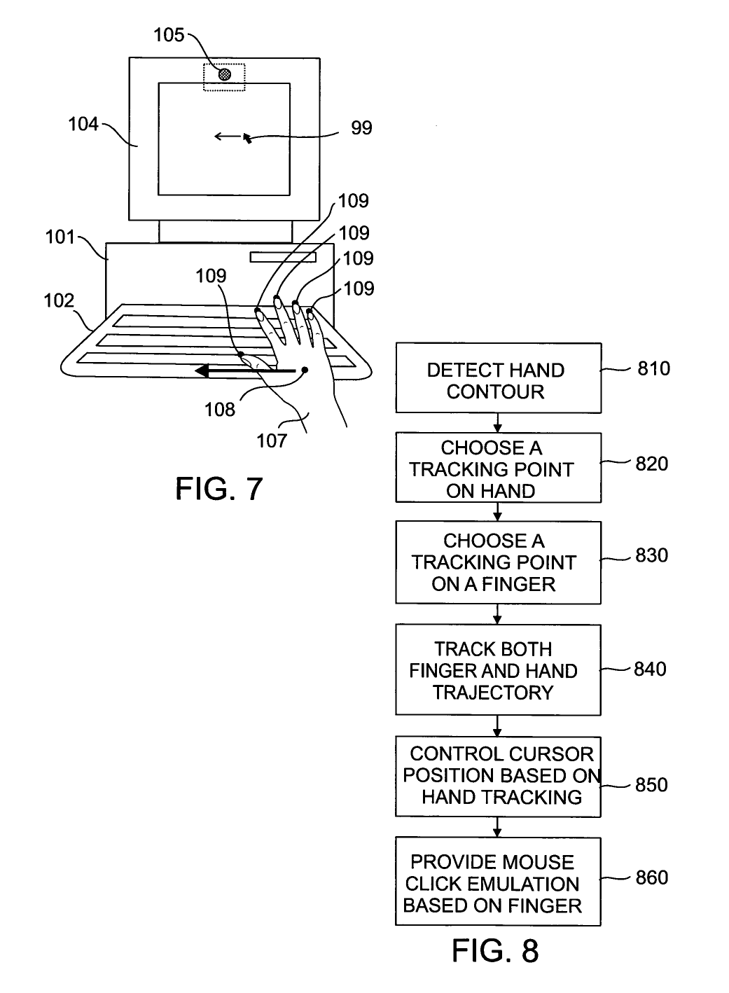

Reference is now made to FIG. 7 showing a simplified diagram of one hand performing exemplary mouse emulation during a PDE mode and to FIG. 8 showing a flow chart of an exemplary method for performing mouse emulation in accordance with some embodiments of the present invention. According to some embodiments of the present invention, during PDE mode, a contour of a hand is detected (block 810). Optionally one or more tracking points 108 within a contour of the base of the hand (without the fingers) are selected for tracking (block 820) and/or one or more tracking points 109 on and/or within the contour of the fingers is selected for tracking (block 830).

According to some embodiments of the present invention, hand tracking point 108 is defined as the center of mass of all pixels of the hand image, e.g. including or excluding fingers. Alternatively, hand tracking point 108 is defined as a position of the farthest pixel of the hand image in a pre-defined direction, e.g. most distal pixel of the fingers. Optionally, hand tracking point 108 is defined as the position of a specific feature of the hand, e.g. the base of the middle finger. Optionally, hand tracking point 108 is defined as the center of mass of multiple hand features. Optionally, hand tracking point 108 is defined as a function of the position of multiple tracking points which are spread over the image of the hand. According to some embodiments of the present invention, selected hand tracking points 108 correspond to locations on the hand's image that have relatively high variance.

According to some embodiments of the present invention, each finger tracking point 109 is defined as the center of mass of all pixels of that finger. Alternatively, each finger tracking point 109 is defined as the most distal pixel of each finger, e.g. distal with respect to the hand.

In some exemplary embodiments, hand tracking point 108 is defined as an average position of all the fingers' positions. An advantage of using the average position of the fingers is that the user may generate minute movements of the hand position by moving a single finger. In another embodiment, the system tracks a three dimensional position of the hand and fingers.

According to some embodiments of the present invention, during PDE activation, tracking points on one or more fingers and the hand are tracked (block 840).

According to some embodiments of the present invention, a position of cursor 99 is controlled by movement of a hand tracking point(s) 108 (block 850). According to some embodiments of the present invention, mouse click emulation is provided by a movement of finger tracking points 109 in relation to hand tracking points 108 or in relation to relative movement between the different finger tracking points (block 860). In some exemplary embodiments, the position of the cursor is controlled by movement of the base of the hand and a first set of fingers, while click emulation is provided by a movement of fingers of a second set of fingers.

In some exemplary embodiments, adduction of the thumb emulates left-mouse-button-down and abduction of the thumb releases emulated left-mouse-button-down. Optionally, moving a finger up (in z-axis) emulates a left-mouse-button-down and moving the finger down emulates releasing left-mouse-button-down. Optionally, a rapid movement of the finger up and down, or down and up, emulates left-mouse-button-down and release. According to some embodiments of the present invention, mouse clicking is emulated by rapid mouse-button-down and release.

According to some embodiments of the present invention, different functions are assigned to each finger tracked. In some exemplary embodiments, movements of the index finger emulate left-mouse-button click or hold, while movements of the middle finger emulate right-mouse-button click or hold. In some exemplary embodiments, abduction of the pinky finger emulates right-mouse-button-down while its adduction emulates release of the right-mouse-button-down.

According to some embodiments of the present invention, the distance between tracking points 109 of different fingers is tracked. In some exemplary embodiments, this distance is used for determining the sensitivity of cursor movement. In some exemplary embodiments, the ratio between a polygon encompassing the hand contour and the area of the hand contour is used to controlling the sensitivity of the cursor movement.

Tracking Fingers Separately from Base of Hand

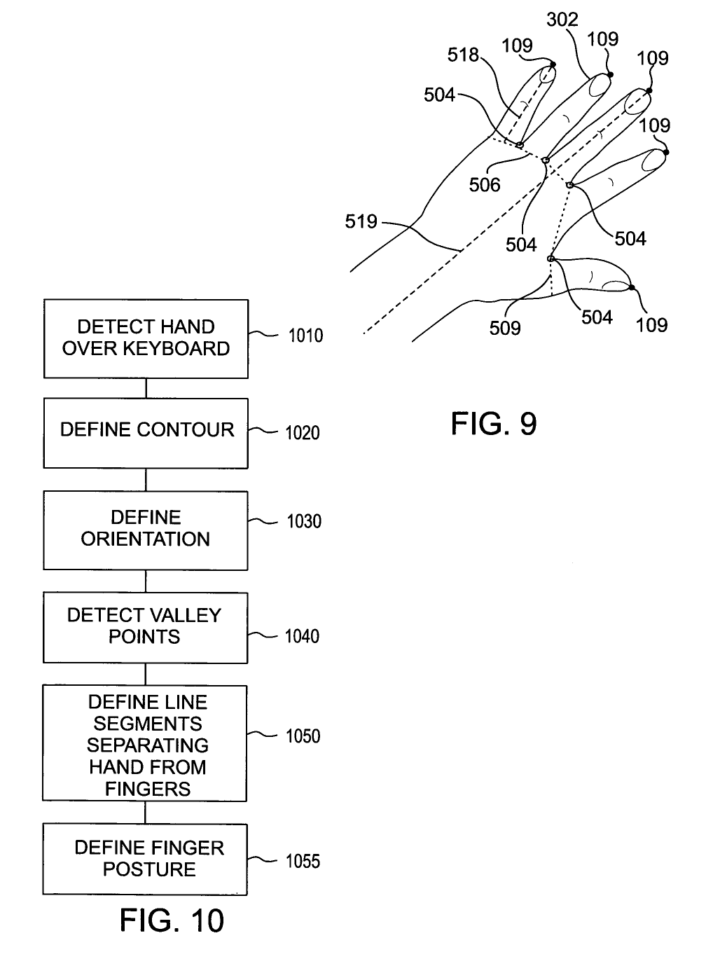

Reference is now made to FIG. 9 showing a simplified diagram of exemplary line segments defined to separate a hand area from each finger area and to FIG. 10 showing an exemplary flow chart of a method for separating a hand area from finger areas in accordance with some embodiments of the present invention.

According to some embodiments of the present invention, system 100 is operative to segment and/or separately identify the area of the base of the hand (hand without fingers) and the area of the fingers, e.g. the area of each finger. Separately identifying the hand area and the finger areas provides means for selectively defining tracking points that are either associated with hand motion, finger motion and/or a desired combination of hand and one or more finger motions. According to some embodiments of the present invention, a hand positioned over a keyboard is detected with camera 105 and a contour 302 is defined (block 1020). In some exemplary embodiments, when two or more fingers are conjoined, the contour of the fingers is defined by following portions of decreased luminance, corresponding to the shadow created between the conjoined fingers.

According to some embodiments of the present invention, based on the contour defined, the orientation of hand 107 is defined (block 1030). For example, the orientation can be determined based on a direction of the longest line that can be constructed by both connecting two pixels of contour 302 and crossing a calculated center of mass of the area defined by contour 302. Exemplary methods for determining orientation are described in more detail herein. Optionally, once orientation is determined, the orientation of contour 302 is normalized to the image coordinate system so that the contour 302 points up.

According to some embodiments of the present invention, four local minimum points 504 in a direction generally perpendicular to longitudinal axis 519 are sought (block 1040). The local minimum points typically correspond to connecting area between the fingers, e.g. the base of the fingers. In some exemplary embodiments, a hand is required to be at least partially abducted to provide for identifying the local minimum. It is noted that, that partial abduction is a typical and natural hand posture usually used when the hand is extended. According to some embodiments of the present invention, an area of each of the three inner fingers, e.g. index finger, middle finger, and ring finger, is defined as all the pixels surrounded by contour 302 and a defined section 506 connecting two adjacent local minimums (block 1050). According to some embodiments of the present invention, an area of each of the two outer fingers, e.g. the thumb and the pinky is defined as all the pixels surrounded by contour 302 and a section line 509 connecting the local minimum with closest pixel 507 on contour 302 in a direction generally perpendicular to longitudinal axis 519.

According to some embodiments of the present invention, based on segmentation, parameters for determining position and/or posture of a finger are defined for tracking (block 1055). In some exemplary embodiments, a tracking point 109 is selected as a point most distal from segment 506 and is used for determining a position of a finger. In some exemplary embodiments, a posture of a finger is defined based on an abduction angle of the finger is defined. In some exemplary embodiments, finger angle is defined as an angle between longitudinal axis 519 of the hand and a longitudinal axis 518 of a finger. In some exemplary embodiments longitudinal axis 518 is defined along the longest line segment that can connect finger tip point 109 to separating segment 506.

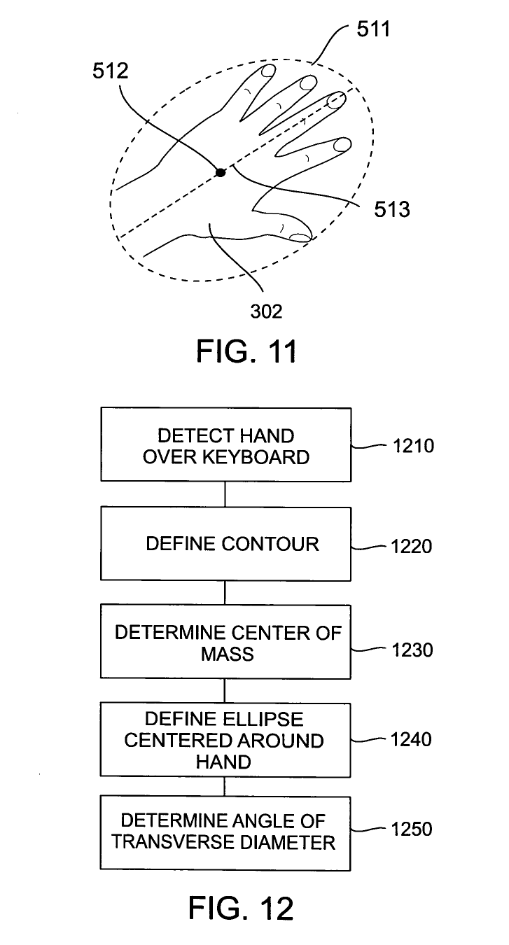

FIG. 11 shows an exemplary simplified diagram of an ellipse defined and used to determine hand orientation and to FIG. 12 showing a flow chart of an exemplary method for determining an orientation of a hand in accordance with some embodiments of the present invention. According to some embodiments of the present invention an image of hand 107 above a keyboard is detected (block 1210). According to some embodiments of the present invention, the contour 302 of hand 107 is defined (block 1220). Optionally, a center of mass 512 of an area defined by the contour, e.g. encompassed by the contour is determined (block 1230). Optionally, an ellipse 511 encompassing contour 302 is defined. Typically, ellipse 511 is defined to closely follow contour 302 and such that the major axis 513 of ellipse 511 crosses center of mass 512.

According to some embodiments of the present invention, one or more specific postures and/or gestures are defined with PDE to control and/or interact with computing device 101. In some embodiments, a posture is used to adjust the speed of cursor movement based on the functionality required. For example, moving the cursor from one Window to another requires a fast inaccurate movement, while choosing a specific pixel in a drawing application requires slow and accurate movement. Optionally, cursor speed is a function of the distance between the hand's fingers.

According to some embodiments of the present invention, mouse scrolling emulation is provided, e.g. vertical and horizontal scroll commands equivalent to the mouse scroll wheel commands. According to some embodiments of the present invention, a gesture is used to activate scrolling, e.g. a scrolling mode. In some exemplary embodiment, abducting all fingers is used as a gesture to activate scrolling. Optionally, rapid abduction and adduction of all fingers, is used to toggle between activated and inactivated scrolling mode.

While the scrolling mode is active, movements of the hands and/or fingers in one or more directions provides for scrolling in that direction. For example, moving the hand left scrolls left, moving the hand away from the user scrolls up. In some embodiments, the distance of the hand from its original position at the onset of scrolling mode is determined and used to set the rate of scrolling. According to some embodiments of the present invention, graphical symbols such as arrows are used to indicate the current scrolling direction. In some embodiments, a circular motion, e.g. movement in a circular path, is used for scrolling. For example a clockwise circular motion is a gesture defined for scrolling down and a counterclockwise circular motion is a gesture defined for scrolling up. Optionally, the speed of the circular motion, e.g. angular speed is calculated and used to set and/or adjust scrolling speed.

In some embodiments when the user's hand or parts of it approach the edges of the camera's viewing area, the cursor continues to move in the last direction and speed it was moving when the hand reached the edge, even if the hand is no longer moving. In other embodiments, the system exits PDE mode upon reaching an edge of a camera's view and then re-enter PDE mode once the hand returns within a certain distance from the edge. In some embodiments, a graphical symbol is displayed to indicate that the user's hand is approaching the edge.

Object Manipulation Performed with a Single Hand

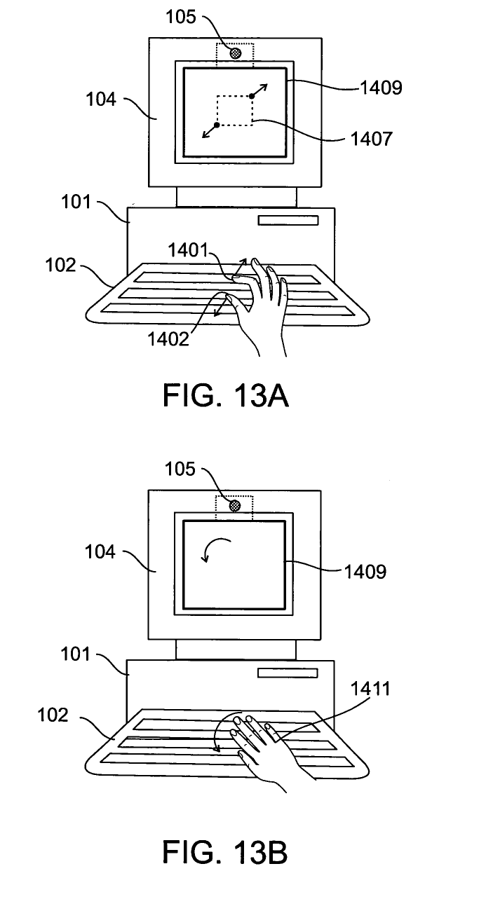

Reference is now made to FIGS. 13A-13B showing simplified diagrams of gestures performed with a single hand for manipulating objects displayed on a visual display in accordance with some embodiments of the present invention.

### Zooming and Resizing

As indicated in FIG. 13A, movement of a tip of an index finger 1401 away from a tip of a thumb 1402 is tracked and used to zoom into area 1407 of image 1409 on electronic display 104. Similarly, movement of a tip of index finger 1401 towards a tip of thumb 1402 is used to zoom out of object 1409.

Alternatively the person can select the object and use a similar gesture to resize. In some exemplary embodiments, an object displayed on display 1409 may be selected based on methods of mouse emulation described herein above then stretched in response to tracking movement of a tip of an index finger 1401 away from a tip of a thumb 1402 and/or condensed in response to tracking movement of a tip of an index finger 1401 toward a tip of a thumb 1402.

### Rotation Gesture

In FIG. 13B, rotation of hand 1411 is tracked and used to rotate an image 1409. According to some embodiments, rotation is tracked based on movement of the base of the hand and two fingers, e.g. ring and pinky finger. The present inventors have found that by including finger tracking during rotation provides for defining a long lever arm from which rotation can be measured and thereby provides more resolution.

In some embodiments, an object is selected and the thumb and index finger are locked on two points associated with the object (and displayed) during rotation.

According to some embodiments of the present invention, one gesture is used to toggle in and out of enhance object manipulation mode, e.g. object manipulation based on control of two points on an object.

Typically, the range of motion of index finger 1401 with respect to thumb 1402 is limited. Similarly, the range of rotation movement of hand 1411 is also limited. According to some embodiments of the present invention, a user can lift the hand to temporarily release hold object 1409, rotate it back or increase/decrease the distance between finger tips while released and then lower the hand to reinstate control so that the gesture can be repeated to increase the range of control, e.g. to continue rotating object 1409, to continue zooming in and/or out of object 1409 and/or to continue enlarging and/or reducing size of object t 1409.

According to some embodiments of the present invention, the gesture used for specific functions, e.g. activating PDE mode, controlling sensitivity of cursor movement, mouse click emulation, are selected by the user from several options, thus allowing each user to customize operation of the system.

### Operation Using Two Hands

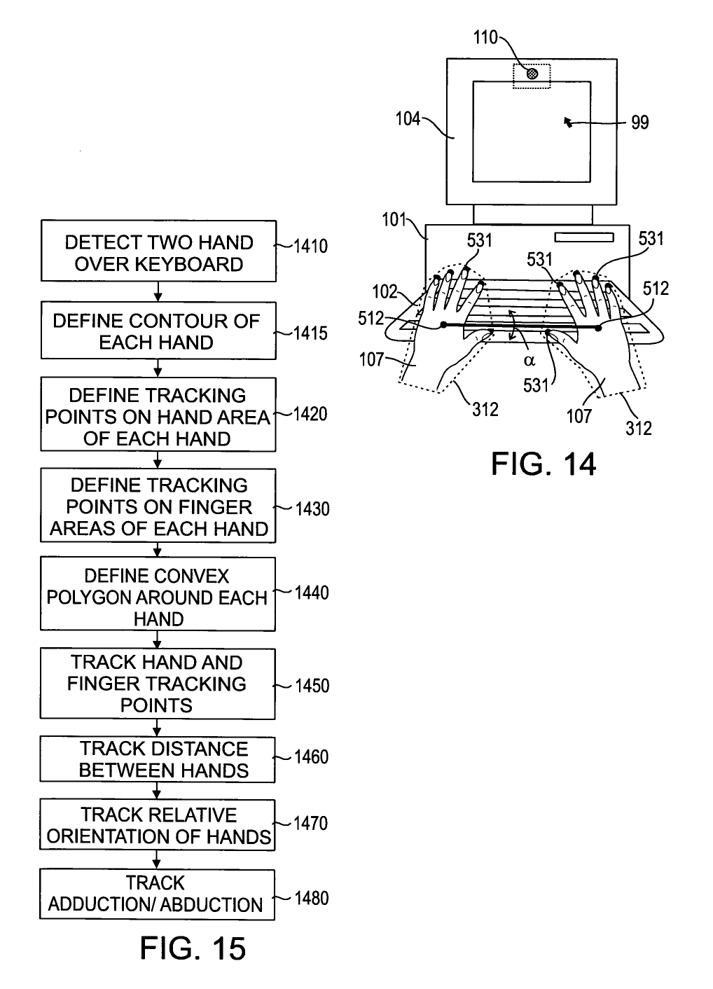

Reference is now made to FIG. 14 showing a simplified diagram of two hands performing exemplary PDE in accordance with some embodiments of the present invention and to FIG. 15 showing a flow chart of an exemplary method for performing PDE with two hands in accordance with some embodiments of the present invention.

According to some embodiments of the present invention, a user uses both hands 107 to operate system 100. In some exemplary embodiments, the system is operative to recognize gestures performed by one hand, e.g. a gesture operative to activate PDE mode or to emulate mouse clicking, while tracking the other hand for cursor movement control. In some embodiments, one hand is tracked to control the position of cursor 99 for as long as the other hand is positioned in a specific posture detected by the system. In some embodiments, system 100 is operative to determine parameters of cursor movement control performed with one hand based on movements or postures of the other hand. In some embodiments, cursor movement control is performed by one hand, while flexing an index finger of the other hand emulates a left mouse click and flexing the middle finger is used to emulate right mouse click. In some embodiments, sensitivity of cursor movement to hand movement of one hand is adjusted based on orientation of the other hand.

According to some embodiments of the present invention, system 100 tracks movement of both hands for interaction with computing device 101. In some embodiments, a zoom-out command is executed in response to the two hands moving away from each other. Similarly in some embodiments, a zoom-in command is executed in response to the two hands approaching each other. In some exemplary embodiments, the magnitude of the zoom-in and zoom-out is based on a detected speed of relative movement between the hands or based on a change in distance between the hands. In some embodiments, a rotate command, e.g. clockwise and/or counter-clockwise rotation is executed in response to rotation of the two hands, e.g. clockwise and/or counter-clockwise rotation. In some embodiments, the rotation angle corresponds to an angle (or a change in angle) of a virtual line connecting a tracking point(s) from each hand.

According to some embodiments of the present invention, two hands 107 are identified on an image (block 1410). According to some embodiments, one or more tracking points are selected on each of the detected hands, e.g. hand tracking points 512 (block 1420) and finger tracking points 109 (block 1430). Optionally, a polygon 312 encompassing one or each of the hands is defined for tracking (block 1440) as described with reference to FIG. 3A-3B. According to some embodiments, movements of each of the tracking points, e.g. tracking points 512 and 109, relative to the image coordinates is tracked (block (1450). In some embodiments, relative positioning or movement of one or more tracking points from each hand is also tracked and/or determined (block 1460). In some exemplary embodiments, relative positioning of tracking points from different hands is determined or tracked and used to determine relative orientation, e.g. an angle □ with respect to image coordinates of a virtual line connecting a tracking point for each hand (block 1470). Optionally, adduction/abduction of each hand is determined and tracked (block 1480) and used to identify one or more gestures.

### Enhancement of Keyboard Inputs Using Computer Vision

According to some embodiments, computer vision information regarding position of a user's fingers on the keyboard, e.g. the part of the keyboard viewed by the camera is used to enhance functionality of the keyboard. According to some embodiments, computer vision of the fingers on the keyboard is implemented to identify the finger used to press each key on the keyboard, e.g. a finger is correlated to each pressed key event. In some exemplary embodiments, the finger closest to the key at the time that a keyboard event of that key is detected is correlated with the keyboard event. In some embodiments, knowledge of the location of the finger in relation to the key being pressed is used to detect and/or fix typing mistakes. For example, a key that is pressed with a finger close to an edge of the key may be considered to result from a possible typing error. In some exemplary embodiments, specific functionality is assigned to one or more fingers. For example, pressing a key with the middle finger is equivalent to pressing that key in conjunction with the ‘Shift’ key. In some embodiments, specific functionality is assigned to each of the hands. For example, pressing a key with a finger from the left hand provides a different function, e.g. an application specific function, as compared to pressing the same key with the right hand.

According to some embodiments of the present invention, keyboard inputs are used to generate a mouse button event during PDE mode. In some embodiments, pressing a key on the keyboard during PDE is interpreted as a mouse click, e.g. left mouse click. In some exemplary embodiments, when the same hand is used for cursor control and for keying the keyboard for emulating clicking, a specific finger used to press a key, e.g. any key, is identified and used to differentiate between different clicking events, e.g. right and left click, double click, and right and left mouse down or up. For example depressing a key on the keyboard with the index finger provides for left mouse click emulation while depressing a key with the ring finger provides for right mouse click emulation. In some exemplary embodiments, specific keys are assigned for each of the different mouse clicks or mouse hold, e.g. left or right mouse click, left or right double mouse click and left or right mouse hold. In some exemplary embodiments, one hand is used for cursor control and the other hand is used for click emulation with keyboard input. Typically, during PDE mode where key pressing is used to execute mouse commands, keyboard input is not directly forwarded to the application software.

In some embodiments, the location of keyboard keys with respect to the image coordinates is pre-defined, e.g. for systems such as laptops where the position of the keyboard is known to be static with respect to the camera. In some exemplary embodiments, for systems where the position of the keyboard with respect to the camera view is subject to change, e.g. in desktop computers the location of the keyboard keys is dynamically updated based on analysis of captured images.

In some exemplary embodiments, the system displays the keyboard keys closest to the index fingers of left and right hand to help seeing impaired typewriters avoid errors.

In some exemplary embodiments, cursor movement is delayed until the system can verify if the movement is a stand alone movement or is part of a gesture. In other embodiments, of the present invention, cursor movement occurring due to a hand movement that turns out to part of a gestures is reverted back to is position prior to performing the gesture once the gesture is recognized.

### User Identification and Security

According to some embodiments of the present invention, visually captured features, e.g. geometrical characteristics of the user's hand, extracted from the video images, are used to identify a particular user interacting with the electronic device and/or is used to identify access permission of a user interacting with the electronic device. Identification may be performed during a login process, over the duration of time that a hand is within the camera view, and/or periodically. In some embodiments, identification is initiated in response to renewed user interaction after a pre-defined period of absence. According to some embodiments, identification performed periodically or entirely over the duration of user interaction provides for preventing a second unauthorized user replacing an authorized used operating the electronic device, e.g. with its keyboard and/or by PDE. In some exemplary embodiments, the electronic device is locked in response to false identification.

According to some embodiments, of the present invention, identification is operative to estimate a user's age, e.g. differentiate between children and adults, based on the size or other geometrical characteristic of the user's hand. In some exemplary embodiments, identification is operative in response to a user requesting access to specific functionalities. For example, identification may provide for using the age information to enable or disable access to specific content or specific applications running on the computer system.

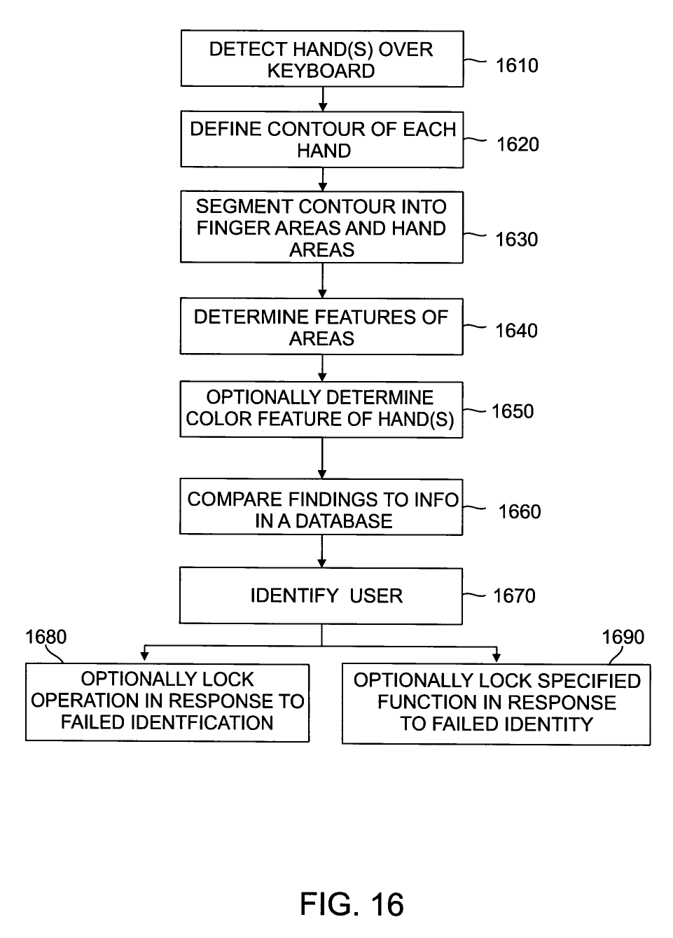

Reference is now made to FIG. 16 showing a flow chart of an exemplary method for identifying a user operating a computing device in accordance with some embodiments of the present invention. According to some embodiments of the present invention, one or more hands over a keyboard are identified by video input (block 1610). According to some embodiments, in response to detection, a contour of each hand is defined (block 1620). In some embodiments, the contour is segmented into finger areas and hand areas (block 1630). According to some embodiments, features of one or more areas are defined (block 1640). Optionally, features may include length of one or more fingers, width of one or more fingers, width of hand area without fingers, distance between finger joints, and/or location of specific or unique features. Optionally, if the absolute values for hand features, e.g. length and width of a finger, are not available at a specific time, relative values are used. In some embodiments, absolute values may be obtained once a user's hand is relatively close to the keyboard, e.g. while attempting to use the keyboard. Optionally, color characteristics of the hand are used as features (block 1650). According to some embodiments of the present invention, one or more identified features are compared to feature information stored in a database (block 1660) and a user is identified based on the detected feature(s) (block 1670).

In some exemplary embodiments, identification provides for identifying a specific user, e.g. a user whose features have been previously characterized and saved. In some exemplary embodiments, identification provides for identifying if a user belongs to a specific group, e.g. age group, or sex (male or female). According to some embodiments of the present invention, identification provides for determining if a current user is authorized to operate the electronic device and/or access information. Optionally, in response to failed authentication of a user as described above, operation of the electronic device is locked (block 1680) or a specific functionality of a running application is locked (block 1690).

### Exemplary Methods for Detecting and Tracking Hands

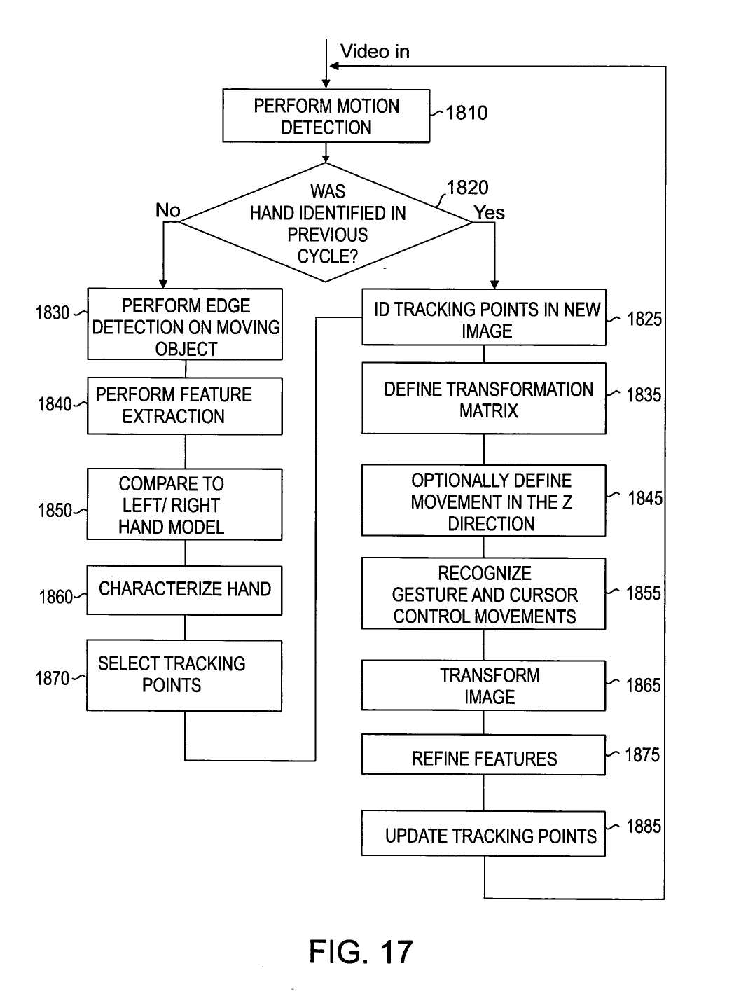

Reference is now made to FIG. 17 showing a flow chart of an exemplary method for identifying and tracking hand motion from a video data stream in accordance with some embodiments of the present invention. According to some embodiments of the present invention, a background image, typically the keyboard, is assumed to be static so that any movement detected is attributed to hand motion. According to some embodiments, a hand contour is distinguished and/or extracted from a background image based on motion detection of detected edges. According to some embodiments of the present invention, a motion detection module is used to detect motion between input images to images from previous cycles (block 1810). In some embodiments the image is compared to the image of the cycle preceding the current cycle. In other embodiments the image is compared to older images or a group of images. Typically, pixels of the images that are significantly different are identified.

According to some embodiments of the present invention, a query is made to determine if a hand was identified in a previous cycle (block 1820). If a hand was not identified, a search mode is entered otherwise a track mode is entered.

According to some embodiments of the preset invention, during search mode edge detection is performed (block 1830). Edge detection methods are known in the art. One example of an edge detection method includes the Canny algorithm available in computer vision libraries such as Intel OpenCV. A description of algorithms available in Intel OpenCV is included in “Open Source Computer Vision Library Reference Manual” with copyright in 2001 to Intel incorporated herein by reference in its entirety. In some exemplary embodiments, edges detection is performed on both the input and output image of the motion detection module. Typically, the input image is the image as captured from the camera and the output image includes black pixels in areas similar to a history frame and white pixels in areas different from the history frame, e.g. previous frame. In other embodiments only one of the images is used for edge detection. When using two edge detection inputs, both edges are combined, wherein edges that appear in both inputs get higher weight than others.

According to some embodiments, of the present invention, feature extraction is performed on the output image, e.g. output image of the motion detector (block 1840). In some exemplary embodiments, feature extraction is also based on edge detection, e.g. features are edges of fingers, wrinkles and spots. Typically, features are edges (as detected by edge detection) that meet some criteria, such as minimal length or certain direction.

According to some embodiments of the present invention, based on edge detection and feature extraction a potential hand area is identified and compared to a left and/or right hand, hand model (block 1850). According to some embodiments of the present invention, matching to a hand model is left and right hand sensitive. Typically, different models are used for the left and right hand. In some exemplary embodiments, based on the matching, the identified hand can be defined as either a right or left hand. Typically, a hand model includes a collection of features, such as edges, that meet a certain set of geometrical rules. An example for a rule is the distance between the features, the angle between the features, the direction of the features, etc. In some exemplary embodiments, matching provides for finding the best match between a subset of the features extracted from the image and the hand model. In some exemplary embodiments, matching provides for determining if the best match is good enough to represent a real hand in the image.

Typically, the matching process is a statistical process that assigns scores to a variety of combinations of features, corresponding to the probability that the specific combination fits the hand model. An example for such a score is the maximal distance from any pixel in the image created by the set of selected features to its closest pixel in the image of the model. Typically, the image of the selected features is normalized before scoring, i.e. shifted, scaled and rotated to have similar center of mass, similar size and similar direction as the model. In some exemplary embodiments, if the score of the best combination exceeds a certain value, a successful match is determined

According to some embodiments of the present invention, in response to a successful match a position of the hand and position of specific parts of the hand, such as fingers and edges of the palm is determined based a calculated correlation between features in the current image and features in the hand model (block 1860). In some exemplary embodiments, edges of each specific finger are joined to create a contour surrounding the finger. In some exemplary embodiments, a virtual connecting line is added to the contour connecting its two open sides at the base of the hand.

In some exemplary embodiments, the width and length of the fingers is determined at this point by analyzing the finger contour. In some exemplary embodiments, a length of a finger is determined as a length of a line between a tip of the contour to the middle of its base. In some embodiments, the width of the finger is defined as the longest section connecting the two sides of the contour and orthogonal to the first line.

According to some embodiments of the present invention, one or more tracking points are defined for tracking hand movements in subsequent images (block 1870). Tracking point selection has been described in detail herein above, e.g. in reference to FIG. 7.

According to some embodiments of the present invention, if a hand was identified in a previous cycle, a track mode is entered. According to some embodiments of the preset invention, during track mode points selected for tracking in previous cycles are searched in an image of the current cycle (block 1825). Tracking methods are known in the art. One example for a tracking method that can be used with some embodiments of the present invention is the Lukas Kanade Optical Flow Optical Flow algorithm available in computer vision libraries such as Intel OpenCV and described in detail on pages 2-18 and 2-19 in incorporated Open Vision Library Reference Manual. In some exemplary embodiments, tracking points on the current image are selected from a plurality of potential tracking based on statistical calculations. For example, the potential tracking points may be sorted into multiple groups, each group stands for a particular displacement of the pixel coordinates between the two images. The group with the majority of points may then be selected to represent the actual displacement. Points belonging to other groups may then be sorted out. In some embodiments, additional parameters such as prior knowledge of the movement of the hand or fingers are used to filter out erroneous tracking points.

According to some embodiments of the present invention, if no tracking points and/or only a small number of tracking points, e.g. smaller than a pre-defined number, are identified on current image, e.g. the hand was moved away from the camera view, tracking mode is terminated and a next image is detected and searched for the presence of a hand.

According to some embodiments of the present invention, a transformation matrix that represents the transform function of the hand from the coordinates of the image of the previous cycle to the image of the current cycle based on the tracking point identification is defined (block 1835). An example of an algorithm that can be used to determine the transformation function include the SVD (Singular Value Decomposition) algorithm available in computer vision libraries such as Intel OpenCV and described in detail on page 14-90 in incorporated Open Vision Library Reference Manual. In some exemplary embodiments, the transformation function is determined for each part of the hand, such as each finger and the back of the hand. According to some embodiments of the present invention the transformation function is used to define hand movement.

According to some embodiments of the present invention, movement in z axis is defined as well based on the scale factor of the transformation matrix (block 1845) as described in reference to FIG. 5.

According to some embodiments of the present invention, cursor control is performed and gesture detection is activated to determine if the movement and/or posture of the hand corresponds to a gesture (1855).

According to some embodiments of the present invention, hand and finger features are transformed to the image coordinates of the current frame (1865) by multiplying the coordinates of each relevant pixel by the transformation matrix calculated. In some exemplary embodiments, accurate location of edges or features of the hand are refined (block 1875). In some exemplary embodiments, an algorithm called Snakes (also called Active Contours) which is available in computer vision libraries such as Intel OpenCV is used to refine edges. In some exemplary embodiments, a location of finger tips is refined by correlating a half circle pattern to the image in the area where the finger tip should be.

According to some embodiments of the present invention, the tracking points to be tracked in a subsequent cycle are updated (1885). Typically, points that were successfully tracked from the previous cycle and were not filtered out are being reused in the current cycle. Points that were filtered out are usually replaced with new points that are selected in a way similar to selection of tracking points during the search mode.

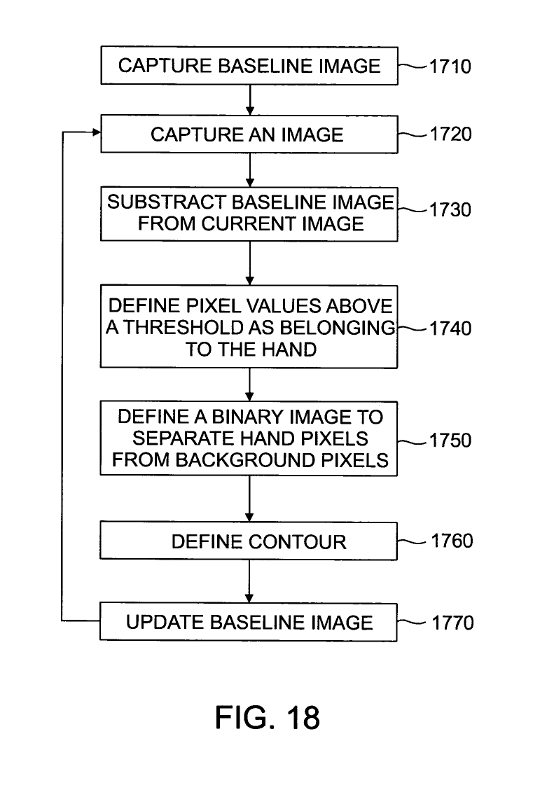

Reference is now made to FIG. 18 showing a flow chart of an alternate method for detecting a hand on a video data stream in accordance with some embodiments of the present invention. This corresponds generally to blocks 410 (FIG. 4), 610 (FIG. 6), 810 (FIG. 8), 1010 (FIG. 10), 1210 (FIG. 12), 1510 (FIGS. 15) and 1610 (FIG. 16). According to some embodiments of the present invention, one or more hands are distinguished and/or extracted from the background based on color and/or luminance analysis of captured images. According to some embodiments of the present invention, during start up and/or during a calibration procedure, an image of the camera view area is captured in the absence of a hand placed within the camera viewing area (block 1710). Optionally, a user is requested to remove the user's hands from the camera view prior to capturing the reference image. Optionally, the image is an average image from a plurality of images captured over time. Optionally, during a calibration procedure, patterns of expected backgrounds, such as typical patterns of keyboards are stored in memory and used as initial reference images. These images are compared to a currently captured image and are updated only in areas where one or more pre-defined features of the current image match features of the reference image. In some embodiments, during a calibration procedure, patterns of typical hands are stored and areas of current images that do not match pre-defined features of the hand images are stored as updated reference background areas.

In some embodiments, the creation of a background image, e.g. the baseline image is a fully automatic process. In other embodiments, the user can monitor the background image and reset it in case it is found to unreliable. In some exemplary embodiments, the user may assist in determining a background color by manually marking pixels of colors that are dominant in the background or pixels of colors dominant in the hand.

In some embodiments, the image is stored in memory and used as a baseline image for comparison with other images, e.g. images including a hand(s). In some exemplary embodiments, one or more average colors of the image, e.g. colors in specific areas of the image is stored in memory and used for comparison with other images. Optionally, other features of the image is stored and used to distinguish between background and hand imaged area.

According to some embodiments, during operation images are captured (block 1720) and delta images are formed by subtracting captured images from the baseline image, baseline color and/or baseline intensity, e.g. subtracting pixel values of a current image with a baseline image (block 1730). Optionally, the current image and baseline image are grayscale images and/or grayscale versions of the images are used to form the delta image. According to some embodiments, pixels in the delta image having values above a pre-defined threshold are identified as belonging to the hand and pixels having a value below the pre-defined threshold are identified as background pixels (block 1740). Optionally, the delta image is a gray level image having values that represents the distance between the current pixel color and the original background color. In some embodiments, a binary image is formed from the delta image, e.g. with a value of ‘0’ for background and ‘1’ for the hand area (block 1750). Optionally, a spatial filter is applied to the delta image and/or binary image, to eliminate noise, defined as small holes in the hands area and background area. Optionally, a time domain filter is applied to further reduce noise. According to some embodiments, a contour of the hand is defined around the area defined by the hand (block 1760).

During operation, the background may change due to changes in lighting conditions, objects in the environment, changes in camera position, camera orientation, and zooming. Optionally, the baseline image is periodically and/or continuously updated by updating the values of background pixels that were identified as not belong to the hand area (block 1770). Optionally, a time domain filter is used for color and/or intensity update process. In some exemplary embodiments, the background is updated using weighted averages that can give more or less weight to image data from a current image.

Optionally, the system tracks movements of the entire background image, to identify changes in the camera position and orientation and adapt the background image accordingly. In some embodiments, a color coordinate system such as YUV, in which Y represents luminance and UV represent two chrominance components, is used to avoid errors due to shadowing. In some exemplary embodiments, during generation of the delta image, a lower weight may be given to luminance differences, thereby reducing the effects of shadows on the delta image.

In some embodiments, pixels belonging to the hand are identified by each pixel's color to an expected hand color rather than to the background image. In some exemplary embodiments, expected hand color may be pre defined or learned by the system during operation, for example by asking the user to place a hand in a predetermined position over the keyboard.

According to some embodiments of the present invention, computer vision provides for tracking position of fingers while a user views a virtual keyboard on display 104 showing finger positions on the virtual keyboard. According to some embodiments of the present invention, a user can key keys on the virtual keyboard by performing a gesture with the finger viewed as being positioned over that key. In some exemplary embodiments, the gesture is defined as rapid lifting and lowering of a finger, e.g. emulating depressing a key.

### The PDE System

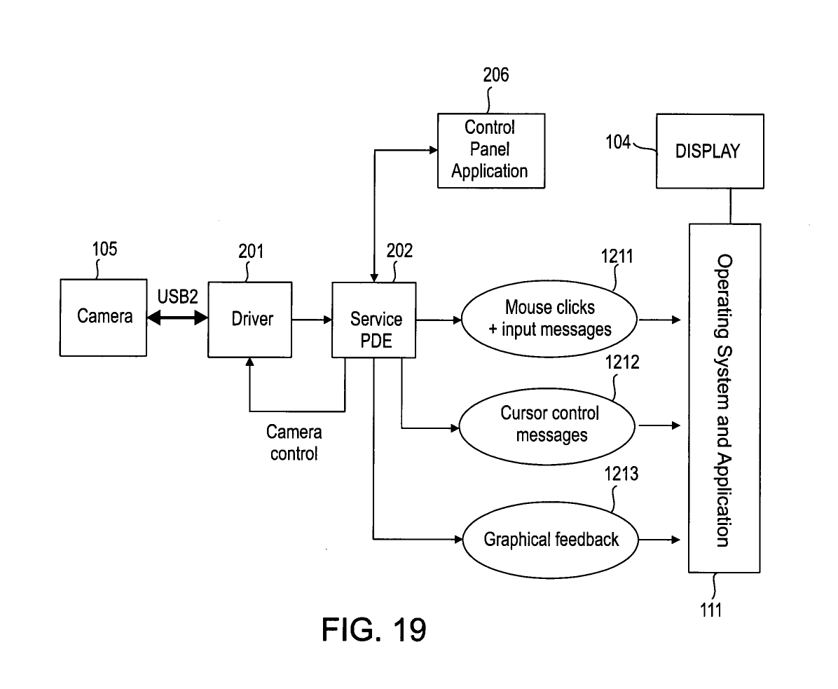

Reference is now made to FIG. 19 showing a simplified block diagram of an exemplary PDE system integrated on a personal computer in accordance with some embodiments of the present invention. FIG. 19 shows a camera 105 controlled by driver 201 produces a stream of images. According to some embodiments of the present invention, a PDE service 202 receives the image stream from camera driver 201 and process the stream to detect hand motion and produce PDE messages based on detected motion. According to some embodiments of the present invention, PDE service 202 includes a computer vision library and a hand detecting module.

According to some embodiments of the present invention, typical messages produced by PDE service 202 include mouse click input messages 1211 to emulate mouse clicking, cursor control messages 1212 to control cursor movement and graphical feedback messages 1213 to control display of objects relating to PDE service, e.g. a PDE symbol or icon. According to some embodiments of the present invention, messages from the PDE are communicated to the Operating System and Applications 111. Typically, PDE service 202 provides messages to alter and/or control display of display screen 104 associated with host 101. According to some embodiments of the present invention, PDE messages mimic messages of standard pointing device so that any user mode application, e.g. software applications can receives PDE Messages and implement.

According to some embodiments of the present invention, PDE service 202 is operative to initiate changes in camera 105 parameters via camera driver 201. For example, PDE service may initiate a required camera gain, camera exposure time, number of frames per second, image resolution, and image contrast.

According to some embodiments of the present invention, a control panel application is operative to define initial settings and/or preferences for operating PDE service 202. In some exemplary embodiments, PDE service can access control panel application when required.

According to some embodiments of the present invention, PDE service 202, or part of the PDE functionality, is embedded on a Digital Signal Processor (DSP) or any other type of processor which is part of the camera, e.g. integrated as part of the camera unit. The DSP or other processor may be a dedicated processor added to the camera for the purpose of PDE or a processor already available in the camera for other purposes. According to some embodiments of the present invention, at least PDE service 202 is embedded in a dedicated adapter located between camera 105 and computing device 101. In some exemplary embodiments, the dedicated adapter includes a dedicated DSP for processing images from camera 105 thus saving computation load from both computing device 101 and camera 105. In some exemplary embodiments, PDE service 202, or part of the PDE functionality, is embedded on a processor of the host 101.

In some exemplary embodiments, the image processing application runs in user mode. Typically, the image processing application runs in very high priority level, such as the Windows Real Time priority since a pointing device requires relatively fast reaction time. In some exemplary embodiments, the image processing unit is a driver which runs in Kernel mode.

### System Providing Toggling Camera Field of View

According to some embodiments of the present invention, camera 105 is connected to a display unit 104, integrated as part of the display unit and/or integrated into other parts of computing device 101. According to some embodiments of the present invention, the camera's view is directed in a typically downward direction to capture images of the keyboard area. In some embodiments, in which an external camera is used; the camera is attached to the upper edge of the monitor using a clip. In some exemplary embodiments, a physical extension is used to increase the distance between the camera and the keyboard surface, thus enabling the capture of the entire keyboard area in cases where the camera has a relatively narrow field of view. Yet in other embodiments the camera is installed on a separate stand, not in contact with the monitor.

According to some embodiments of the present invention, a mirror is used to redirect a view of a camera from a forward facing view to a keyboard view. Such a mirror may be integrated with the screen or be attached to the screen as an accessory. In some exemplary embodiments, the camera is moveably mounted on a rotating axis so that its view can be controllably toggled between keyboard viewing and forward viewing. In some exemplary embodiments, a mirror is positioned in front of the camera, facing down at an angle of about 45 degrees, causing the camera to view the keyboard area, and subsequently folded away to provide for forward view, e.g. a view a user's face. Optionally, the camera view is adjusted and/or set manually by the user. Optionally, the camera view is controlled electronically by software applications or system drivers.

In some exemplary embodiments, the mirror is flat and does not change the original viewing angle of the camera. In some exemplary embodiments, concave and/or convex mirror is used to decrease and/or increase the camera viewing angle and adapt it to the required system viewing area. In some exemplary embodiments, a prism is used instead of a mirror. Optionally, the mirror or prism may, be embedded and integrated into the camera rather than being external to the camera. In some exemplary embodiments, a single camera is used both for capturing hand images over the keyboard, e.g. when the mirror is opened and for capturing images of the user's face, e.g. when the mirror is closed or folded, e.g. for video conferencing. In other exemplary embodiments, at least one camera is dedicated for capturing images of the keyboard.

In some exemplary embodiments, external light is used for image capture. In some exemplary embodiments, a light source is used, e.g. visual and/or infrared light source. It is noted that the camera may be a camera providing color images and/or a grey scale camera. In some exemplary embodiments, the viewing angle of the camera provides for capturing images of the entire keyboard. In some exemplary embodiments, only part of the keyboard viewed by the camera and PDE is only provided in the viewing area of the camera.

According to some embodiments of the present invention, a wide angle camera, e.g. having a view of between 90-135 degrees is used to concurrently capture images of the keyboard and a user's face. In some exemplary embodiments, the captured image is divided into an area viewing the keyboard, e.g. a PDE area, and an area viewing the user's face.

In some exemplary embodiments, two separate image sensors are mounted on a single camera module, the first one facing forward towards the user face and the second one facing down towards the keyboard. Other camera components such as processing and communication units may be shared between both sensors. It should be noted that the specifications of the two cameras or sensors (i.e. resolution, refresh rate, color capabilities, etc) may differ from each other. In some exemplary embodiments of the present invention, the camera used by the input device works in the visual light range, while in other embodiments, it is sensitive to infrared light or to both visible and infrared light.

In some exemplary embodiments, the camera is interfaced to the PC with a Universal Serial Bus Version 2.0 (USB2). Other embodiments may use a different type of interface. It is noted that computing device 101 may be any computing device associated with an electronic display 104 and an interaction surface, e.g. a keyboard 102 including desktop computers with separate monitors and keyboards, laptop and notebook computer having integrated monitors and keyboards and/or a all in one computer where the motherboard and other peripherals are located in the back of the monitor. Other exemplary computing and/or electronic devices that receive input from PDE service 202 include a mobile phone and a stand alone display screens with a virtual interaction surface of keyboard and mouse. It is noted that PDE can be integrated with any operating system that supports point device input, e.g. Windows Macintosh OS and Linux.

It is noted that although methods for tracking hand movements and identifying gestures have been described herein, the present invention is not limited to the methods described. Optionally, known methods for detection human hand postures and gestures may be implemented. An article titled “AN INTRODUCTION AND OVERVIEW OF A GESTURE RECOGNITION SYSTEM IMPLEMENTED FOR HUMAN COMPUTER INTERACTION” by ISAAC D. GERG, in www.gergltd.com/thesis.pdf downloaded on Mar. 29, 2009 and which is incorporated by reference herein, teaches a method for detection of human hand gestures, such as “Open hand open fingers” and “Open hand closed fingers”. Another known method for hands gesture recognition, such as “open hand gesture”, is described in an article named “TELEVISION CONTROL BY HAND GESTURES” written by William T. Freeman and Craig D. Weismann, published online at www.merl.com/papers/docs/TR94-24.pdf, and downloaded on Mar. 29, 2009 is incorporated by reference herein. This method uses a normalized correlation of a template hand to the image to analyze the user hand. An article named “Real-Time Hand Tracking and Gesture Recognition for Human-Computer Interaction” by Cristina Manresa, Javier Varona, Ramon Mas and Francisco J. Perales, at wvvw.dmi.uib.es/˜ugiv/papers/ELCVIAManresa.pdf downloaded on Mar. 29, 2009 which is incorporated by reference herein, teaches an additional method for detection of a “fully opened hand (with separated fingers)” and an “opened hand with fingers together” using relatively low computation resources.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

While several exemplary embodiments of the invention have been described in detail above, those skilled in the art will recognize other embodiments and variations which come within the scope of the invention. It is accordingly understood that the scope of the invention is not intended to be limited by the written description herein, but rather is to be given the full scope permitted by the following claims.

1-84. (canceled)

85. A method for object movement control in a device associated with an electronic display, the method comprising:
capturing images of at least one hand;
tracking movement of the at least one hand;
providing object movement control of the object, said object displayed on the electronic display, the movement control based on the tracking of the hand movement; and
if the hand movement is a gesture, providing object position at the object's position prior to performance of the gesture.

86. The method according to claim 85 wherein
tracking of the hand movement comprises tracking a position of a base of the hand;
and wherein
a gesture consists of movement of at least one finger or part of finger.

87. The method according to claim 85 further comprising:
tracking at least one finger or part of finger; and
providing interaction in addition to object movement control based on tracking the at least one finger part or finger.

88. The method according to claim 87, wherein the object movement control is based on tracking the base of the hand and a first set of fingers of the hand and interaction in addition to object movement control is based on tracking one or more fingers from a second set of fingers.

89. The method according to claim 87, wherein providing interaction in addition to object movement control comprises providing emulation of mouse clicking.

90. The method according to claim 87, wherein providing interaction in addition to object movement control is based on a gesture performed by the at least one finger or part or finger.

91. The method according to claim 90, wherein a gesture associated with mouse click down is defined by adduction of the finger and mouse click up is defined by abduction of the finger.

92. The method according to claim 91, wherein the finger is a thumb.

93. The method according to claim 90, wherein a gesture associated with mouse click is defined by flexion and extension of a finger.

94. The method according to claim 90, wherein a gesture associated with mouse click is defined by a finger lifting and lowering movement.

95. The method according to claim 90, further comprising:
identifying the finger or part of finger performing the gesture; and
performing one of right mouse click, left mouse click, right mouse down, left mouse down, right mouse up, left mouse up based on the identifying.

96. The method according to claim 87, wherein providing interaction in addition to object movement control comprises changing a parameter of the object movement control.

97. The method according to claim 96, wherein the parameter is resolution or sensitivity of movement control.

98. The method according to claim 97, wherein the resolution is determined based on a distance between fingers.

99. The method according to claim 85, wherein the images captured of the at least one hand are captured over a keyboard.

100. The method according to claim 85 further comprising:
controlling object movement based on the tracking, object movement control continued while the hand is performing a gesture with hand motion; and
in response to identifying the gesture, restoring the object position to the object's position prior to performance of the gesture.

101. The method according to claim 85, wherein object movement control comprises at least one of dragging the object, scrolling, rotation of the object, resiting of the object and zooming.

102. The method according to claim 85, wherein the object is a cursor.

103. A method for object movement control in a device associated with an electronic display, the method comprising:
capturing images of at least one hand;
tracking a position and posture of the at least one hand from the images captured;
providing control of an object displayed on the electronic display based on the tracking of the position of the hand; and
defining a resolution or sensitivity of the control based on the posture of the hand.

104. The method according to claim 103 wherein tracking a position and posture of the at least one hand comprises tracking a position of a base of the at least one hand and tracking at least one finger of the hand.

105. The method according to claim 104, wherein a distance between at least two fingers defines the resolution of the control of the object.
